(19) United States
(12) Patent Application Publication
(10) Pub. No.: US 2026/0164169 A1
(43) Pub. Date: Jun. 11, 2026

(54) Sound Apparatus and Vehicular Apparatus Comprising the Same

(71) Applicant: LG Display Co., Ltd., Seoul (KR)

(72) Inventors: JeongMan Lee, Paju-si (KR); Jongho Jeong, Paju-si (KR)

(21) Appl. No.: 19/183,170

(22) Filed: Apr. 18, 2025

(30) Foreign Application Priority Data
Dec. 9, 2024 (KR) 10-2024-0181650

(51) Int. Cl. H04R 1/28; B60R 11/02; H04R 1/02; H04R 17/00

(52) U.S. Cl. CPC H04R 1/2811; B60R 11/0217; H04R 1/025; H04R 17/00; H04R 2499/13

(57) ABSTRACT

A sound apparatus comprises a sound generating module including a vibration member and a vibration apparatus configured to vibrate the vibration member, an enclosure connected to the vibration member and having an opening portion overlapping the vibration apparatus, and a vibration control member disposed around the vibration apparatus in a gap space between the enclosure and a rear surface of the vibration member and connected between the enclosure and the rear surface of the vibration member. The vibration control member is disposed to be inclined with respect to a side of the vibration apparatus.

### CROSS-REFERENCE TO RELATED APPLICATION

This application claims the benefit of and priority to Republic of Korea Patent Application No. 10-2024-0181650 filed on Dec. 9, 2024, which is hereby incorporated by reference in its entirety.

### BACKGROUND

### Technical Field

The present disclosure relates to a sound apparatus and a vehicular apparatus including the same.

### Description of the Related Art

Vehicles include a sound apparatus which outputs a sound based on an audio signal output from a multimedia device such as a car audio device or the like. For example, the sound apparatus applied to vehicles may include a front speaker and a rear speaker, which are configured as a coil type.

### SUMMARY

A sound apparatus in the vehicles may be limited when outputting a realistic sound or stereo sound of a multichannel through the front speaker and the rear speaker to limitations of the coil type device. Further, in the sound apparatus in vehicles, in a case where the number of speakers is increased, stereo sound may be output, but due to a size of the speakers based on the coil type device and a limitation of a space in vehicles, there is a limitation in increasing the number of speakers so that a realistic sound or stereo sound cannot be provided using the coil type device.

The inventors of the present disclosure have recognized the problems and disadvantages of the related art and have performed extensive research and experiments for enhancing a sound characteristic and/or a sound pressure level characteristic of a sound apparatus for vehicles. Based on the extensive research and experiments, the inventors have invented a sound apparatus and a vehicular apparatus including the same, which may enhance a sound characteristic and/or a sound pressure level characteristic.

An embodiment of the present disclosure is directed to providing a sound apparatus and a vehicular apparatus including the same, which may enhance a sound characteristic and/or a sound pressure level characteristic.

An embodiment of the present disclosure is directed to providing a sound apparatus and a vehicular apparatus including the same, which may enhance a sound characteristic and/or a sound pressure level characteristic in a pitched sound band including a sound of a low-pitched sound band.

Additional features, advantages, and embodiments of the present disclosure are set forth in part in the present disclosure and will also be apparent from the present disclosure or may be learned by practice of the inventive concepts provided herein. Other features, advantages, and aspects of the present disclosure may be realized and attained by the descriptions provided in the present disclosure, or derivable therefrom, and claims hereof as well as the appended drawings.

To achieve these and other advantages and embodiments of the present disclosure, as embodied and broadly described herein, in one or more embodiments, a sound apparatus comprises a sound generating module including a vibration member and a vibration apparatus configured to vibrate the vibration member, an enclosure connected to the vibration member and having an opening portion overlapping the vibration apparatus, and a vibration control member disposed around the vibration apparatus in a gap space between the enclosure and a rear surface of the vibration member and connected between the enclosure and the rear surface of the vibration member. The vibration control member is disposed to be inclined with respect to a side of the vibration apparatus.

In the sound apparatus according to one or more embodiments of the present disclosure, the vibration apparatus includes a short side and a long side. The vibration control member is disposed at one or more of the short side and the long side of the vibration apparatus or is in contact with one of the short side and the long side of the vibration apparatus.

The sound apparatus according to one or more embodiments of the present disclosure further comprises a coupling member connected between a rear edge of the vibration member and the enclosure to provide a gap space. The vibration control member is disposed between the vibration apparatus and the coupling member within the gap space and is in contact with the coupling member or spaced apart from the coupling member.

The vehicular apparatus according to one or more embodiments of the present disclosure comprises an interior material exposed at an interior space, and at least one or more sound generating apparatuses disposed at the interior material to output a sound to the interior space. The at least one or more sound generating apparatuses comprise a sound apparatus. The sound apparatus comprises a sound generating module including a vibration member and a vibration apparatus configured to vibrate the vibration member, an enclosure connected to the vibration member and having an opening portion overlapping the vibration apparatus, and a vibration control member disposed around the vibration apparatus in a gap space between the enclosure and a rear surface of the vibration member and connected between the enclosure and the rear surface of the vibration member. The vibration control member is disposed to be inclined with respect to a side of the vibration apparatus.

Details of other exemplary embodiments will be included in the detailed description of the disclosure and the accompanying drawings.

According to a sound apparatus and a vehicular apparatus including the same according to one or more embodiments of the present disclosure, a sound characteristic and/or a sound pressure level characteristic may be enhanced.

According to a sound apparatus and a vehicular apparatus including the same according to one or more embodiments of the present disclosure, a sound characteristic and/or a sound pressure level characteristic may be enhanced in a sound band including a sound of a low-pitched sound band.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure, are incorporated in and constitute a part of this disclosure, illustrate aspects and embodiments of the disclosure and together with the description serve to explain principles of the disclosure.

FIG. 1 is a diagram illustrating a sound apparatus according to an embodiment of the present disclosure.

FIG. 2 is a perspective view illustrating a sound apparatus according to an embodiment of the present disclosure.

FIG. 3 is an exploded perspective view illustrating a sound apparatus according to an embodiment of the present disclosure.

FIG. 4 is a cross-sectional view taken along I-I′ illustrated in FIG. 2 according to an embodiment of the present disclosure.

FIG. 5 is a cross-sectional view taken along II-II′ illustrated in FIG. 2 according to an embodiment of the present disclosure.

FIG. 6 is a diagram for explaining a vibration control member according to a first embodiment of the present disclosure.

FIG. 7 is a diagram for explaining a vibration control member according to a second embodiment of the present disclosure.

FIG. 8 is a diagram for explaining a vibration control member according to a third embodiment of the present disclosure.

FIG. 9 is a diagram for explaining a vibration control member according to a fourth embodiment of the present disclosure.

FIG. 10 is a diagram for explaining a vibration control member according to a fifth embodiment of the present disclosure.

FIG. 11 is a diagram for explaining a vibration control member according to a sixth embodiment of the present disclosure.

FIG. 12 is a diagram for explaining a vibration control member according to a seventh embodiment of the present disclosure.

FIG. 13 is a diagram for explaining a vibration control member according to an eighth embodiment of the present disclosure.

FIG. 14 is an exploded perspective view illustrating a sound apparatus according to another embodiment of the present disclosure.

FIG. 15 is a cross-sectional view taken along III-III′ illustrated in FIG. 14 according to an embodiment of the present disclosure.

FIG. 16 is a diagram illustrating a sound apparatus according to another embodiment of the present disclosure.

FIG. 17 is a cross-sectional view taken along IV-IV′ illustrated in FIG. 16 according to an embodiment of the present disclosure.

FIG. 18 is a diagram illustrating a vibration apparatus according to an embodiment of the present disclosure.

FIG. 19 is a cross-sectional view taken along V-V′ illustrated in FIG. 18 according to an embodiment of the present disclosure.

FIG. 20 is a cross-sectional view taken along VI-VI′ illustrated in FIG. 18 according to an embodiment of the present disclosure.

FIG. 21 is a diagram illustrating a vehicular apparatus according to an embodiment of the present disclosure.

FIG. 22 is a diagram illustrating a vehicular apparatus according to an embodiment of the present disclosure.

FIG. 23 is a diagram illustrating a sound generating apparatus disposed at a roof of a vehicular apparatus illustrated in FIGS. 21 and 22.

FIG. 24 is a diagram illustrating a sound generating apparatus disposed at a roof and a seat of a vehicular apparatus illustrated in FIGS. 21 and 22 according to an embodiment of the present disclosure.

FIG. 25 is a diagram illustrating sound output characteristics of a sound apparatus according to embodiments of the present disclosure and experimental examples.

FIG. 26 is a diagram illustrating sound output characteristics of a sound apparatus according to embodiments of the present disclosure and experimental examples.

FIG. 27 is a diagram illustrating sound output characteristics of a sound apparatus according to embodiments of the present disclosure and experimental examples.

FIG. 28 is a diagram illustrating sound output characteristics of a sound apparatus according to embodiments of the present disclosure and experimental examples.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and convenience.

### DETAILED DESCRIPTION

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure may be thorough and complete to assist those skilled in the art to understand the inventive concepts without limiting the protected scope of the present disclosure.

A shape, a size, a ratio, an angle, and a number disclosed in the drawings for describing embodiments of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. In a situation where “comprise,” “have,” and “include” described in the present disclosure are used, another part may be added unless “only” is used. The terms of a singular form can include plural forms unless referred to the contrary.

In construing an element, the element is construed as including an error range although there is no explicit description.

In describing a position relationship, for example, when a position relation between two parts is described as “on,” “over,” “under,” and “next,” one or more other parts may be disposed between the two parts unless ‘just’ or ‘direct’ is used.

For the expression that an element is “connected,” “coupled,” or “contact,” to another element, the element may not only be directly connected, coupled, or contacted to another element, but also be indirectly connected, coupled, or contacted to another element with one or more intervening elements interposed between the elements, unless otherwise specified.

For the expression that an element is “contacts” or “overlaps” with another element, the element can not only directly contact, overlap, or the like with another element, but also indirectly contact or overlap with another element with one or more intervening elements disposed or interposed between the elements, unless otherwise specified.

The terms “a first direction,” “a second direction,” “a third direction,” “X-axis direction,” “Y-axis direction,” and “Z-axis direction” should not be construed by a geometric relation only of a mutual vertical relation and may have broader directionality within the range that elements of the present disclosure may act functionally.

Features of various embodiments of the present disclosure may be partially or overall coupled to or combined with each other and may be variously inter-operated with each other and driven technically as those skilled in the art can sufficiently understand. The embodiments of the present disclosure may be carried out independently from each other or may be carried out together in co-dependent relationship.

Hereinafter, example embodiments of a sound apparatus according to the present disclosure will be described in detail with reference to the accompanying drawings. For convenience of description, a scale of each of elements illustrated in the accompanying drawings differs from a real scale, and thus, is not limited to a scale illustrated in the drawings.

FIG. 1 is a diagram illustrating a sound apparatus according to an embodiment of the present disclosure. For example, FIG. 1 illustrates a sound apparatus for vehicles according to an embodiment of the present disclosure.

Referring to FIG. 1, a sound apparatus 30 according to an embodiment of the present disclosure may be disposed or equipped at an inner portion of a vehicle 10 to output a sound S toward an interior space (or an indoor space) IS of the vehicle (or a vehicular apparatus) 10.

The vehicle 10 may be a vehicular apparatus which includes one or more seats and one or more windows. For example, the vehicle 10 may include a vehicle, a train, a ship, or an aircraft, or the like.

The vehicle 10 according to an embodiment may include a main structure 110.

The main structure 110 of the vehicle 10 may include a main frame, a sub-frame, a side frame, a door frame, an under-frame, and a seat frame, or the like, but embodiments of the present disclosure are not limited thereto. For example, the main structure 110 may be a vehicle body, a vehicle structure, or a frame structure, or the like.

The vehicle 10 according to an embodiment may further include a vehicle exterior material 120.

The vehicle exterior material 120 may be configured to cover an outer portion of the main structure 110. For example, the vehicle exterior material 120 may include a hood panel, a front fender panel, a dash panel, a pillar panel, a trunk panel, a roof panel (or ceiling), a floor panel, a door inner panel, and a door outer panel, or the like. For example, the vehicle exterior material 120 may include one or more of a planar portion (or a flat portion) and a curved portion (or a flexural portion or an uneven portion).

The vehicle 10 according to an embodiment may further include a vehicle interior material 130.

The vehicle interior material 130 may include all elements (or components) configuring an inner portion of the vehicle 10 or may include all elements disposed at the interior space IS of the vehicle 10. For example, the vehicle interior material 130 may be an interior member or an interior finish material of the vehicle 10.

The vehicle interior material 130 may be configured to cover one or more of main structure 110 and the exterior material 120 in the interior space (or an inner portion) IS of the vehicle 10. The vehicle interior material 130 may be configured to be exposed at the inner portion and/or the interior space IS of the vehicle 10 in the inner portion and/or the interior space IS of the vehicle 10. For example, the vehicle interior material 130 may be configured to cover one or more surfaces (or an interior surfaces) of at least one or more of a main frame (or a vehicle body), a side frame (or a side body), a door frame (or a door body), a handle frame (or a steering hub), and a seat frame, which are exposed at the interior space IS of the vehicle 10.

The vehicle interior material 130 according to an embodiment of the present disclosure may include a dashboard, a pillar interior material (or a pillar trim), a floor interior material (or a floor carpet), a roof interior material (or a headliner), a door interior material (or a door trim), a handle interior material (or a steering cover), a seat interior material, a rear package interior material (or a back seat shelf), an overhead console (or an illumination interior material), a rear view mirror, a glove box, and a sun visor, or the like.

The vehicle interior material 130 according to an embodiment may include one or more materials of metal, wood, rubber, plastic, glass, fiber, cloth, paper, a mirror, leather, and carbon. For example, the vehicle interior material 130 including a plastic material may be an injection material which is implemented by an injection process using a thermoplastic resin or a thermosetting resin.

The vehicle interior material 130 according to an embodiment may include one or more of a planar portion (or a flat portion) and a curved portion (or a flexural portion or an uneven portion). For example, the vehicle interior material 130 may have a structure corresponding to a structure (or an inner surface structure) of a corresponding main structure 110 or may have a structure which differs from a structure of a corresponding main structure 110.

The sound apparatus 30 according to an embodiment may be disposed at the vehicle interior material 130. The sound apparatus 30 may be configured to output the sound S toward the inner portion and/or the interior space IS of the vehicle 10. The sound apparatus 30 may be configured to indirectly or directly vibrate the vehicle interior material 130 to output the sound S toward the inner portion and/or the interior space IS of the vehicle 10. For example, the vehicle interior material 130 may have a size which is greater than the sound apparatus 30.

According to an embodiment, the sound apparatus 30 may be configured to indirectly or directly vibrate one or more of a dashboard, a pillar interior material, a floor interior material, a roof interior material, a door interior material, a handle interior material, a seat interior material, a rear package interior material, an overhead console, a rear view mirror, a glove box, and a sun visor to output the sound S toward the inner portion and/or the interior space IS of the vehicle 10.

The vehicle 10 according to an embodiment may include one or more sound apparatuses 30 disposed at or connected to one or more regions (or portions) of the vehicle interior material 130. The one or more sound apparatuses 30 may vibrate the one or more regions (or portions) of the vehicle interior material 130 to output a realistic sound S and/or stereo sound including a multichannel toward the interior space IS of the vehicle 10.

The sound apparatus 30 according to an embodiment may be disposed at a region between the vehicle interior material 130 and the main structure 110, or a region between the vehicle interior material 130 and the vehicle exterior material 120 and may be configured to output the sound S toward the inner portion and/or the interior space IS of the vehicle 10. The sound apparatus 30 according to another embodiment may be disposed at a region between the vehicle interior material 130 and the main structure 110, or a region between the vehicle interior material 130 and the vehicle exterior material 120, and may indirectly or directly vibrate one or more of the main structure 110, the vehicle exterior material 120, and the vehicle interior material 130 to output sound S. In this case, one or more of the main structure 110, the vehicle exterior material 120, and the vehicle interior material 130 may output a sound S based on driving (or vibration or displacement) of one or more the sound apparatus 30.

According to an embodiment, one or more of the vehicle exterior material 120 and the vehicle interior material 130 of the vehicle 10 may be a vibration plate, a sound vibration plate, or a sound generating plate, or the like to output a sound S. For example, each of the vehicle exterior material 120 and the vehicle interior material 130 to output the sound may have a size (or an area) which is greater than that of the sound apparatus 30, and thus, may perform a function of a large-area vibration plate, a large-area sound vibration plate, or a large-area sound generating plate, thereby enhancing a sound characteristic and/or a sound pressure level characteristic of a sound band including a low-pitched sound band generated by the sound apparatus 30. For example, a frequency of a sound of the low-pitched sound band may be 300 Hz or less, 400 Hz or less, or 500 Hz or less.

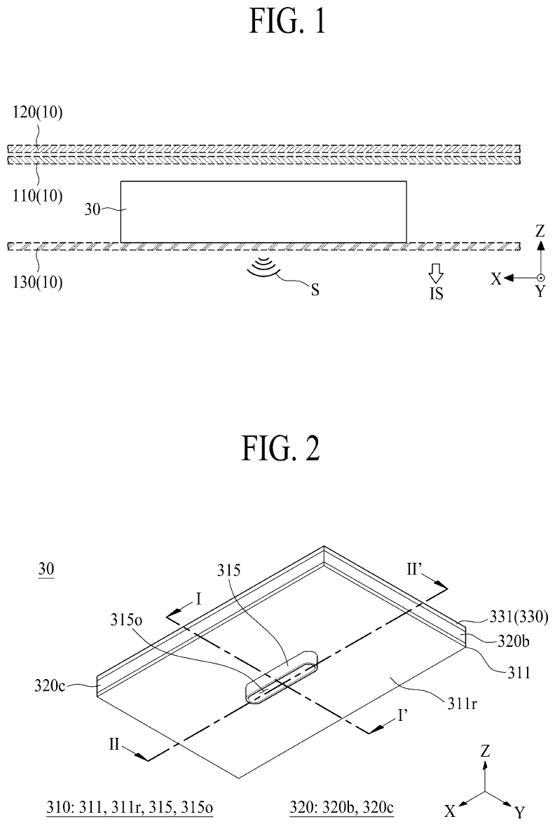

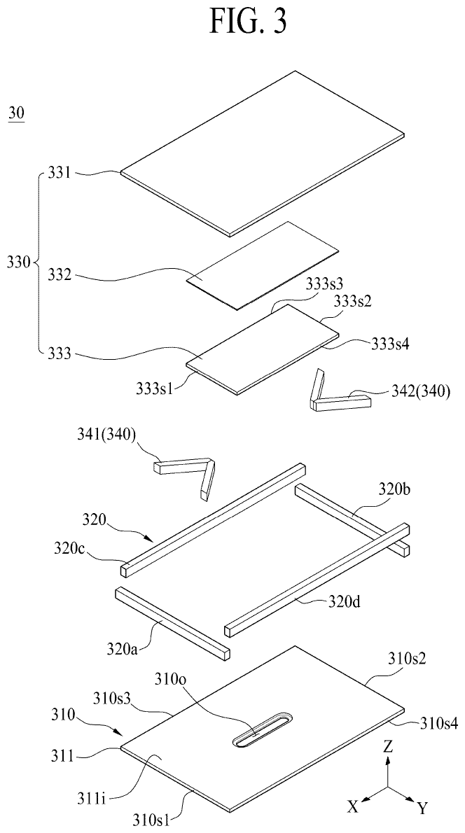

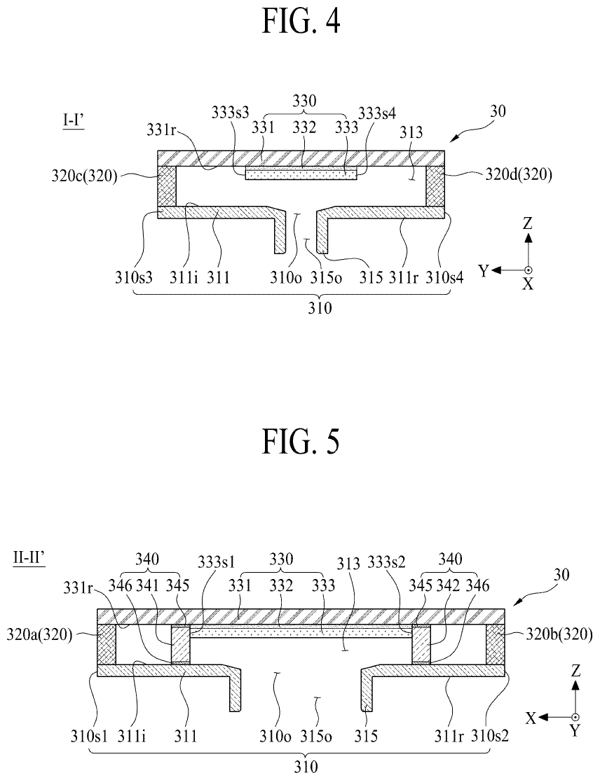

FIG. 2 is a perspective view illustrating a sound apparatus according to an embodiment of the present disclosure. FIG. 3 is an exploded perspective view illustrating a sound apparatus according to an embodiment of the present disclosure. FIG. 4 is a cross-sectional view taken along I-I′ illustrated in FIG. 2 according to an embodiment of the present disclosure. FIG. 5 is a cross-sectional view taken along II-II′ illustrated in FIG. 2 according to an embodiment of the present disclosure.

Referring to FIGS. 2 to 5, a sound apparatus 30 (or a sound apparatus for vehicles) according to an embodiment of the present disclosure may be configured to vibrate a vibration object or a vehicle structure. For example, the sound apparatus 30 may be a sound generating apparatus, a sound output apparatus, a speaker apparatus, a car audio device, or an audio apparatus.

The sound apparatus 30 may be configured to be connected (or coupled) to the vibration object or the vehicle structure. For example, the sound apparatus 30 may vibrate any one of the main structure 110, the vehicle exterior material 120, and the vehicle interior material 130 illustrated in FIG. 1 to generate (or output) a sound.

The sound apparatus 30 according to an embodiment of the present disclosure may include an enclosure 310, a coupling member 320, a sound generating module 330, and a vibration control member 340.

The enclosure 310 may be around the sound generating module 330. The enclosure 310 may be configured to support the sound generating module 330. The enclosure 310 may be configured to cover one side surface (or a bottom surface) of the sound generating module 330.

The enclosure 310 according to an embodiment of the present disclosure may include one or more materials of a metal material and a nonmetal material (or a composite nonmetal material). For example, the enclosure 310 may include one or more materials of a metal material, plastic, fiber, carbon, and wood. For example, the enclosure 310 may be configured in a metal material such as aluminum (Al) material or configured in a plastic material such as plastic or styrene material. For example, the styrene material may be an ABS material. The ABS material may be acrylonitrile, butadiene, and styrene.

The enclosure 310 may have a rectangular shape having long sides and short sides. For example, in the enclosure 310, the long sides may be parallel to a first direction X, and the short sides may be parallel to a second direction Y intersecting the first direction X, but is not limited thereto. For example, the enclosure 310 may include a first short side 310s1, a second short side 310s2 parallel to the first short side 310s1, a first long side 310s3, and a second long side 310s4 parallel to the first long side 310s3.

The enclosure 310 may include a plate 311 (or an enclosure member or a plate member). The plate 311 may have a rectangular shape having long sides and short sides. The plate 311 may be disposed or configured below (or under) the sound generating module 330. The plate 311 may be disposed or configured to be spaced apart from the sound generating module 330. The plate 311 (or the enclosure 310) may include a first side 311i and a second side 311r opposite to the first side 311i. The first side 311i of the plate 311 may be spaced apart from the sound generating module 330 or may face the sound generating module 330. For example, the first side 311i of the plate 311 may be a front surface or an inner surface. The second surface 311r of the first plate 311a may be connected (or coupled) to the vibrating object or the vehicle structure. For example, the second surface 311r of the plate 311 may include a non-flat structure having a curved surface.

The sound generating module 330 may be disposed or configured on the enclosure 310 or the plate 311. For example, the sound generating module 330 may be configured to be supported by the enclosure 310. The sound generating module 330 may generate vibration or output sound (or sound waves or sound pressure). For example, the sound generating module 330 may be a sound generating unit, a sound generating member, a sound reproduction module, a sound reproduction unit, a car audio module, a car audio unit, a speaker module, or a speaker unit.

The sound generating module 330 according to an embodiment may include a vibration member 331 and a vibration apparatus 333.

The vibration member 331 may be disposed or configured on the enclosure 310 or the plate 311. For example, the vibration member 331 may be configured to be supported by the enclosure 310.

The vibration member 331 may generate vibration or output sound (or sound waves or sound pressure) based on the driving (or vibration) of the vibration apparatus 333. For example, the vibration member 331 may be a diaphragm, a vibration plate, a vibration substrate, a vibration panel, a sound plate, a sound panel, a passive vibration plate, a passive vibration member, a passive vibration panel, a sound output plate, or a sound vibration plate, but is not limited thereto.

The vibration member 331 may include a single nonmetal material or a composite nonmetal material. The single nonmetal material or the composite nonmetal material of the vibration member 331 may include one or more material of wood, rubber, plastic, carbon, glass, fiber, cloth, paper, mirror, and leather, but is not limited thereto. For example, the vibration member 331 may be composed of a same material as the enclosure 310 or the plate 311 or may be composed of a different material from the enclosure 310 or the plate 311.

The vibration member 331 according to an embodiment may be composed of a plastic material or a plastic material of styrene material, but is not limited thereto. The vibration member 331 according to another embodiment of the present disclosure may be composed of a porous material. For example, the vibration member 331 may include a micro cellular plastics material. The vibration member 331 composed of the micro cellular plastics may have capability to reproduce a high original sound because having a low density and an excellent elastic force, thereby enhancing the quality of a sound.

The vibration apparatus 333 may be configured to vibrate (or displace) the vibration member 331. For example, the vibration apparatus 333 may be configured to vibrate (or displace or drive) based on a driving signal (or a vibration driving signal or a voice signal) applied thereto to vibrate (or displace or drive) the vibration member 331. For example, the vibration apparatus 333 may be configured to include a piezoelectric material having a piezoelectric characteristic. For example, the vibration apparatus 333 may be a piezoelectric type vibration apparatus.

The vibration apparatus 333 may have a shape corresponding to or a same shape as the vibration member 331, but is not limited thereto. The vibration apparatus 333 may have a size smaller than the vibration member 331. A center of the vibration apparatus 333 may be disposed or aligned with a center of the vibration member 331. For example, the vibration apparatus 333 may have a different shape from the vibration member 331.

The vibration apparatus 333 according to an embodiment may include a rectangular shape having long sides and short sides. For example, the vibration apparatus 333 may include a first short side (or first side wall) 333s1, a second short side (or second side wall) 333s2 parallel to the first short side 333s1, a first long side (or third side wall) 333s3, and a second long side (or fourth side wall) 333s4 parallel to the first long side 333s3. For example, the first short side 333s1 of the vibration apparatus 333 may be parallel to the first short side 310s1 of the enclosure 310 (or the plate 311), and the second short side 333s2 of the vibration apparatus 333 may be parallel to the second short side 310s2 of the enclosure 310 (or the plate 311). The first long side 333s3 of the vibration apparatus 333 may be parallel to the first long side 310s3 of the enclosure 310 (or the plate 311), and the second long side 333s4 of the vibration apparatus 333 may be parallel to the second long side 310s4 of the enclosure 310 (or the plate 311).

The vibration apparatus 333 may be disposed between the vibration member 331 and the enclosure 310 (or the plate 311). The vibration apparatus 333 may be connected or coupled to one side (or a rear surface) 331r of the vibration member 331 so as to be spaced from the enclosure 310 (or the plate 311).

The sound apparatus 30 or the sound generating module 330 according to an embodiment of the present disclosure may further include an adhesive member 332. The vibration apparatus 333 may be connected or attached to the vibration member 331 by the adhesive member 332.

The adhesive member 332 may be disposed (or interposed) between the vibration member 331 and the vibration apparatus 333. For example, the vibration apparatus 333 may be connected or attached to the one side (or rear surface) 331r of the vibration member 331 by the adhesive member 332.

The adhesive member 332 according to an embodiment of the present disclosure may include epoxy, acrylic, silicone, or urethane, but is not limited thereto. For example, the adhesive member 332 may include an acrylic material (or substance), having a characteristic where an adhesive force is relatively good and hardness is relatively high compared to a urethane material. Accordingly, the vibration of the vibration apparatus 330 may be efficiently transferred to the vibration member 331.

The coupling member (or a joint member) 320 may be configured to provide a gap space 313 between the enclosure 310 (or plate 311) and the vibration member 331. The coupling member 320 may be configured to connect or couple the vibration member 331 and the enclosure 310 to each other. For example, the gap space 313 may be a space between the enclosure 310 (or plate 311) surrounded by the coupling member 320 and the vibration member 331. For example, the gap space 313 may be an internal space or a resonance space of the sound apparatus 300.

The coupling member 320 may be connected or coupled between the enclosure 310 and the vibration member 331 so as to surround the side walls 333s1, 333s2, 333s3, and 333s4 of the vibration apparatus 333. For example, the coupling member 320 may be spaced apart from the side walls 333s1, 333s2, 333s3, and 333s4 of the vibration apparatus 333. For example, the coupling member 320 may include a frame shape (or a ring shape) having a rectangular shape having an opening portion. For example, the coupling member 320 may be configured to be connected or coupled between an edge portion of the vibration member 331 and an edge portion of the enclosure 310 (or the plate 311). For example, a central region of the enclosure 310 (or the plate 311) may directly face the vibration apparatus 333. The middle region between the center region and the edge portion of the enclosure 310 (or plate 311) may directly face one side (or rear surface) 331r of the vibration member 331.

The coupling member 320 according to an embodiment may include first to fourth coupling members 320a, 320b, 320c, and 320d.

The first coupling member 320a may be connected or coupled between a first edge portion adjacent to the first short side 310s1 of the enclosure 310 (or plate 311) and a first edge portion of the vibration member 331. The second coupling member 320b may be connected or coupled between a second edge portion adjacent to the second short side 310s2 of the enclosure 310 (or plate 311) and a second edge portion of the vibration member 331. The third coupling member 320c may be connected or coupled between a third edge portion adjacent to the first long side 310s3 of the enclosure 310 (or plate 311) and a third edge portion of the vibration member 331. The fourth connection member 320d may be connected or coupled between a fourth edge portion adjacent to the second long side 310s4 of the enclosure 310 (or plate 311) and a fourth edge portion of the vibration member 331.

Each of the first to fourth connection members 320a, 320b, 320c, and 320d may be configured to have a predetermined width and a predetermined height to provide the gap space 313.

The coupling member 320 (or the first to fourth coupling members 320a, 320b, 320c, and 320d) may be configured to minimize the transfer of vibration of the vibration member 331 to the enclosure 310 (or the plate 311). The coupling member 320 (or the first to fourth coupling members 320a, 320b, 320c, and 320d) may include material characteristic suitable for blocking the vibration. For example, the coupling member 320 (or the first to fourth coupling members 320a, 320b, 320c, and 320d) may include a material having elasticity for vibration absorption (or impact absorption). The coupling member 320 (or the first to fourth coupling members 320a, 320b, 320c, and 320d) according to an embodiment of the present disclosure may be composed of polyurethane materials or polyolefin materials, but is not limited thereto. For example, the coupling member 320 (or the first to fourth coupling members 320a, 320b, 320c, and 320d) may include one or more of a double-sided foam tape, a double-sided adhesive foam tape, a double-sided foam pad, a double-sided adhesive foam pad, and a double-sided cushion tape, but is not limited thereto.

The enclosure 310 according to another embodiment may further include a sidewall portion. The sidewall portion may be configured (or disposed) along the edge portion of the plate 311. For example, the sidewall portion may be vertically connected to the edge portion of the plate 311. For example, the sidewall portion may be configured at the edge portion of the plate 311 to support the sound generating module 330 (or the vibration member 331). The sidewall portion may be connected or coupled to an edge portion of the sound generating module 330 (or the vibration member 331) through the coupling member 320. For example, when the enclosure 310 includes the sidewall portion, the coupling member 320 may be configured to have a relatively thin thickness. For example, when the coupling member 320 has a relatively thick thickness, the sidewall portion of the enclosure 310 may be omitted.

The enclosure 310 or the plate 311 according to an embodiment of the present disclosure may include an opening portion 310o.

The opening portion 310o may be configured to penetrate (or vertically penetrate) the enclosure 311 along a thickness direction Z (or a vertical direction) of the enclosure 310 (or plate 311). The opening portion 310o may be configured to penetrate (or vertically penetrate) a center of the enclosure 310 (or plate 311).

The opening portion 310o may face or directly face one side (or a rear surface) of the vibration apparatus 333. The opening portion 310o may be connected to (or communicated with) the gap space 313. For example, the gap space 313 may be connected to (or communicated with) an external space of the enclosure 310 (or the plate 311) through the opening portion 310o.

The opening portion 310o may be configured to decrease an air pressure in the gap space 313. The opening portion 310o may be configured to decrease the air pressure in the gap space 313a which is provided between the enclosure 310 (or the plate 311) and the vibration member 331. Accordingly, the low-pitched sound band of the sound generated based on the vibration of the sound generating module 330 (or the vibration apparatus 333) may be expanded, and thus sound characteristics of the low-pitched sound band may be improved. For example, as the pressure (or air pressure) of the gap space 313a is lowered by the opening portion 310o, the displacement amount (or vibration amplitude or displacement amplitude) of the vibration member 331 may be increased, and thus, the low-pitched sound band may be expanded, and a sound characteristic and/or a sound pressure level characteristic of the low-pitched sound band may be improved. Accordingly, the sound characteristic and/or the sound pressure level characteristic of the low-pitched sound band generated based on the vibration (or displacement) of the vibration member 331 by the driving (or vibration or displacement) of the sound generating module 330 (or the vibration apparatus 333) may be improved.

The opening portion 310o may be disposed to correspond to a center of the sound generating module 330 (or the vibration apparatus 333). The opening portion 310o may be spaced apart from the center of the sound generating module 330 (or the vibration apparatus 333). The opening portion 310o may have a size smaller than a size of the vibration apparatus 333.

The opening portion 310o may be formed (or configured) at the enclosure 310 (or the plate 311) so as to be parallel to the first direction X or parallel to the long sides 333s2 and 333s4 of the vibration apparatus 333. For example, the opening portion 310o may be extended long in the first direction X or a long-side length direction of the vibration apparatus 333. For example, the opening portion 310o may include a line shape passing through the center of the sound generating module 330 (or the vibration apparatus 333) or may include a rectangular shape.

The opening portion 310o may include a short axis and a long axis. For example, the opening portion 310o may include a width (or a short-axis length) parallel to the second direction Y or a short-side length direction of the enclosure 310 and a length (or a long-axis length) parallel to the first direction X or a long-side length direction of the enclosure 310. For example, the length of the opening portion 310o may be smaller than the length (or long-axis length) of the vibration apparatus 333. For example, the opening portion 310o may be a hole, an opening line, a line hole, a slot, or a slit. For example, the opening portion 310o may be a sound emission portion, a sound emission port, an sound output portion, an sound output port, an sound output hole, a duct hole, or a vent hole, but is not limited thereto.

The opening portion 310o may be a space through which sound (or sound waves or sound pressure) generated based on the vibration of the sound generating module 330 (or the vibration apparatus 333) is output to the external space of the enclosure 310. For example, the sound (or sound waves or sound pressure) generated based on the vibration (or displacement) of the vibration member 331 by the vibration of the sound generating module 330 (or the vibration apparatus 333) may be output (or emitted) to the external space of the enclosure 310 through the opening portion 310o. For example, since the sound is generated based on the vibration of the vibration member 331 having a size greater than that of the sound apparatus 30, a sound characteristic and/or a sound pressure level characteristic of a sound including the low-pitched sound band may be enhanced.

The sound apparatus 30 or the enclosure 310 according to another embodiment of the present disclosure may further include a protrusion portion 315. The plate 311 of the enclosure 310 may further include a protrusion portion 315.

The protrusion portion 315 may be configured (or formed) to surround the opening portion 310o of the enclosure 310 (or plate 311). The protrusion portion 315 may include an opening hole (or a hollow hole or a sound output hole) 315o corresponding (connected) to the opening portion 310o. For example, the opening portion hole 315o may correspond to the opening portion 310o or have a same shape as the opening portion 310o.

The protrusion portion 315 may protrude from the rear (or outer surface) 311r of the enclosure 310 (or the plate 311) to surround the opening portion 310o. For example, the protrusion portion 315 may protrude from the rear surface (or an outer surface) 311r of the enclosure 310 (or the plate 311) to have the opening portion hole 315o. Accordingly, the sound (or sound wave or sound pressure) generated based on the vibration (or displacement) of the vibration member 331 by the vibration of the sound generating module 330 (or the vibration apparatus 333) may be output (or emitted to the external space of the enclosure 310 through the opening portion 310o and the opening portion hole 315o of the protrusion portion 315.

The vibration control member 340 may be configured to control (or limit) vibration of the vibration member 331. The vibration control member 340 may be configured to control (or limit) a vibration (or a partial vibration or an undesired vibration) of the vibration member 331 in a peripheral region of the vibration apparatus 333 which is not connected to (or overlapped with) the vibration apparatus 333. The vibration control member 340 according to an embodiment may be configured to control (or limit) the vibration (or partial vibration or undesired vibration) of the vibration member 331 in a peripheral region of one or more of the short sides and the long sides of the vibration apparatus 333 which is not connected to (or overlapped with) the vibration apparatus 333. For example, the vibration control member 340 may be in contact (or directly in contact) with any one of the short sides and the long sides of the vibration apparatus 333 or may be spaced apart from any one of the short sides and the long sides of the vibration apparatus 333. For example, the vibration control member 340 may be a clamp, a clamping member, a vibration adjustment member, a vibration limiting member, a vibration restraining member, a displacement control member, a displacement adjustment member, or a displacement restraining member, but is not limited thereto.

For example, the vibration generated by the vibration member 331 based on the vibration (or displacement) of the vibration apparatus 333 may include an in-phase component and an anti-phase component. For example, the in-phase component may contribute to increasing the sound pressure level output, and the anti-phase component may contribute to decreasing the sound pressure level output. For example, when the anti-phase component generated based on the vibration of the vibration member 331 is decreased (or suppressed), the sound pressure level characteristic may be improved.

The vibration control member 340 may be configured to decrease (or suppress) the anti-phase component of the vibration generated by the vibration (or displacement) of the vibration member 331 based on the vibration (or displacement) of the vibration apparatus 333. For example, the vibration control member 340 may be configured to decrease (or suppress) the anti-phase component corresponding to a sound band (or a sound frequency) of the low-pitched sound band (for example, 200 Hz to 1 kHz) among vibrations generated when the vibration member 331 vibrates. Accordingly, the vibration control member 340 may improve (or enhance) a sound characteristic and/or a sound pressure level characteristic of the low-pitched sound band (for example, 200 Hz to 1 kHz) generated based on the vibration (or displacement) of the vibration member 331.

The vibration control member 340 may be disposed (or configured) in the gap space 313 between the enclosure 310 (or the plate 311) and the vibration member 331. The vibration control member 340 may be disposed around the vibration apparatus 333 within the gap space 313 and connected (or coupled) between the enclosure 310 (or the plate 311) and the vibration member 331. For example, the vibration control member 340 may be disposed (or configured) in the gap space 313 between the first surface 311i of the plate 311 and one surface (or the rear surface) 331r of the vibration member 331.

The vibration control member 340 according to an embodiment is disposed to be inclined (or at an inclined angle) around one or more of the short side and the long side of the vibration apparatus 333 within the gap space 313 and may be in contact with any one of the short side and the long side of the vibration apparatus 333. For example, the vibration control member 340 may be disposed (or configured) to be inclined with respect to the side of the vibration apparatus 333. The vibration control member 340 may be disposed (or configured) to be inclined with respect to the short side (or the short-side length direction) of the vibration apparatus 333.

The vibration control member 340 may include a first side (or upper side) and a second side (or lower side) opposite to the first side. The first side of the vibration control member 340 may be connected to (or attached to) the vibration member 331. For example, the first side of the vibration control member 340 may be connected to (or attached to) the vibration member 331 by using a first adhesive layer (or adhesive member) 345. The second side of the vibration control member 340 may be connected to (or attached to) the enclosure 310 (or the plate 311). For example, the second side of the vibration control member 340 may be connected to (or attached to) the enclosure 310 (or the plate 311) by using a second adhesive layer (or adhesive member) 346.

The vibration control member 340 may be disposed around the short sides 333s1 and 333s2 of the vibration apparatus 333. The vibration control member 340 may be disposed between the coupling member 320 and the short sides 333s1 and 333s2 of the vibration apparatus 333. For example, the vibration control member 340 may be disposed to be in contact with (or in direct contact with) the short sides 333s1 and 333s2 of the vibration apparatus 333 or to be spaced apart from the short sides 333s1 and 333s2 of the vibration apparatus 333. For example, one side (or one sidewall) of the vibration control member 340 may be disposed to be in contact (or in direct contact) with the short side 333s1 and 333s2 of the vibration apparatus 333 or spaced apart from the short side 333s1 and 333s2 of the vibration apparatus 333.

For example, when the vibration apparatus 333 vibrates (or displacements), the short side of the vibration apparatus 333 may have a relatively greater displacement width (or vibration width) than the center of the vibration apparatus 333, and thus, the in-phase component of the vibration may be high in the short side of the vibration apparatus 333 and the anti-phase component of the vibration may be high in the periphery of the short side of the vibration apparatus 333. Accordingly, the vibration control member 340 may be disposed (or configured) around the short side 333s1 and 333s2 of the vibration apparatus 333 or may be disposed (or configured) to be in contact (or in direct contact) with the short side 333s1 and 333s2 of the vibration apparatus 333. Therefore, the vibration control member 340 may improve (or enhance) the sound characteristic and/or the sound pressure level characteristic of the low-pitched sound band (for example, 200 Hz to 1 kHz) generated based on the vibration (or displacement) of the vibration member 331 by decreasing (or suppressing) the anti-phase component generated around the short sides 333s1 and 333s2 of the vibration apparatus 333 based on the vibration of the vibration member 331.

The vibration control member 340 according to an embodiment may include a first vibration control member 341 and a second vibration control member 342.

The first vibration control member 341 may be disposed (or configured) to be inclined around the first short side 333s1 of the vibration apparatus 333. The first vibration control member 341 may be disposed to be inclined between the coupling member 320 and the first short side 333s1 of the vibration apparatus 333. For example, the first vibration control member 341 may be disposed to be inclined between the first coupling member 320a of the coupling member 320 and the first short side 333s1 of the vibration apparatus 333. For example, the first vibration control member 341 may be in contact with (or directly in contact with) or spaced apart from the first short side 333s1 of the vibration apparatus 333 between the first coupling member 320a and the first short side 333s1 of the vibration apparatus 333. For example, the first vibration control member 341 may be in contact with (or directly in contact with) or spaced apart from the first coupling member 320a of the coupling member 320.

The second vibration control member 342 may be disposed (or configured) to be inclined around the second short side 333s2 of the vibration apparatus 333. The second vibration control member 342 may be disposed to be inclined between the coupling member 320 and the second short side 333s2 of the vibration apparatus 333. For example, the second vibration control member 342 may be disposed to be inclined between the second coupling member 320b of the coupling member 320 and the second short side 333s2 of the vibration apparatus 333. For example, the second vibration control member 342 may be in contact with (or directly in contact with) or spaced apart from the second short side 333s2 of the vibration apparatus 333 between the second coupling member 320b and the second short side 333s2 of the vibration apparatus 333. For example, the second vibration control member 342 may be in contact with (or directly in contact with) or spaced apart from the second coupling member 320b of the coupling member 320.

Each of the first vibration control member 341 and the second vibration control member 342 may be configured to have a “V”-shape, a “>”-shape, or a “<”-shape by one or more vibration control pads, but is not limited thereto.

The vibration control member 340 (or the first and second vibration control members 341 and 342) may be composed of a material having a material characteristic suitable for controlling (or adjusting or limiting or suppressing) vibration of a portion of the vibration member 331. For example, the vibration control member 340 (or the first and second vibration control members 341 and 342) may be composed of a different material from the coupling member 320. For example, the vibration control member 340 (or the first and second vibration control members 341 and 342) may be composed of a relatively stiffer material (or a hard material) or a material having high elasticity (or Young's modulus) than the coupling member 320.

The vibration control member 340 (or the first and second vibration control members 341 and 342) may be made of a stiff material (or a hard material). For example, the vibration control member 340 (or the first and second vibration control members 341 and 342) may be made of a material having high elasticity (or Young's modulus) and high tensile strength.

The vibration control member 340 (or the first and second vibration control members 341 and 342) according to an embodiment may be made of a plastic material or a metal material.

The vibration control member 340 (or the first and second vibration control members 341 and 342) according to another embodiment may be rubber, but is not limited thereto. For example, the rubber may be ethylene propylene rubber or urethane rubber. For example, the ethylene propylene rubber may be ethylene propylene diene monomer (EPDM). For example, a hardness of the EPDM may be 40 to 90. For example, a tensile strength of the EPDM may be 50 kg/cm² to 200 kg/cm².

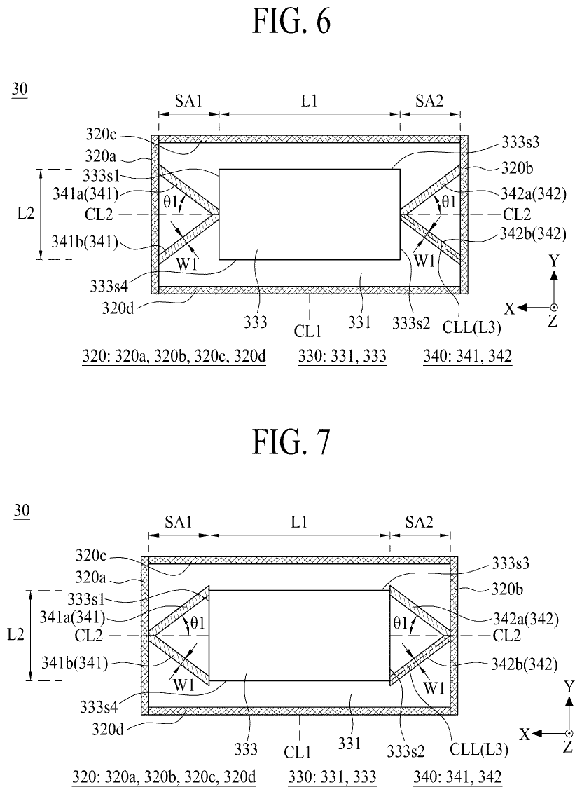

FIG. 6 is a diagram for explaining a vibration control member according to a first embodiment of the present disclosure.

Referring to FIGS. 5 and 6, the vibration control member 340 according to the first embodiment of the present disclosure may include a first vibration control member 341 and a second vibration control member 342.

Each of the first and second vibration control members 341 and 342 may have a height corresponding to a distance between the enclosure 310 (or plate 311) and the vibration member 331.

The first vibration control member 341 and the second vibration control member 342 may be disposed (or configured) with respect to the center of the vibration member 331 (or the vibration apparatus 333. For example, the first vibration control member 341 and the second vibration control member 342 may be disposed (or configured) symmetrically (or horizontal symmetrically) with respect to a center line CL1 of a long-side length L1 of the vibration member 331 (or the vibration apparatus 333). For example, the center line CL1 of the long-side length L1 of the vibration member 331 (or the vibration apparatus 333) may be a first center line CL1 which is parallel to the short side of the vibration apparatus 333 and passes through a center of the long-side length L1 of the vibration apparatus 333.

The first vibration control member 341 may be disposed in a first short-side area SA1 adjacent to the first short side 333s1 of the vibration apparatus 333. For example, the first vibration control member 341 may be disposed in the first short-side area SA1 between the first short side 333s1 of the vibration apparatus 333 and the coupling member 320. The first vibration control member 341 may be disposed in the first short-side area SA1 to have an inclined surface (or a slope surface) which is inclined with respect to the first short side 333s1 of the vibration apparatus 333. The first vibration control member 341 may be disposed to be in contact (or directly in contact) with the first short side 333s1 of the vibration apparatus 333. The first vibration control member 341 may be disposed to be in contact (or directly in contact) with the first coupling member 320a of the coupling member 320.

The first vibration control member 341 may include a 1-1^{th} vibration control pad 341a and a 1-2^{th} vibration control pad 341b disposed to be inclined with respect to the first short side 333s1 of the vibration apparatus 333.

Each of the 1-1^{th} and 1-2^{th} vibration control pads 341a and 341b may include a line shape (or a bar shape) having a predetermined width W1. For example, the width W1 of each of the 1-1^{th} and 1-2^{th} vibration control pads 341a and 341b may be equal to a width of the coupling member 320, but is not limited thereto. For example, the width W1 of each of the 1-1^{th} and 1-2^{th} vibration control pads 341a and 341b may be greater than the width of the coupling member 320.

Each of the 1-1^{th} and 1-2^{th} vibration control pads 341a and 341b may be disposed (or configured) to be inclined between the first coupling member 320a of the coupling member 320 and the first short side 333s1 of the vibration apparatus 333. Each of the 1-1^{th} and 1-2^{th} vibration control pads 341a and 341b may be disposed (or configured) to be in contact with the first short side 333s1 of the vibration apparatus 333 and the first coupling member 320a.

One end (or a first end) of each of the 1-1^{th} and 1-2^{th} vibration control pads 341a and 341b may be in contact with the first short side 333s1 of the vibration apparatus 333. The one end of each of the 1-1^{th} and 1-2^{th} vibration control pads 341a and 341b may be in contact with (or connected to) each other and may be in contact with the first short side 333s1 of the vibration apparatus 333. The one end of each of the 1-1^{th} and 1-2^{th} vibration control pads 341a and 341b, which are in contact with each other, may be in contact with the center of the first short side 333s1 of the vibration apparatus 333.

The other end (or a second end) opposite to the one end of each of the 1-1^{th} and 1-2^{th} vibration control pads 341a and 341b may be in contact with the first coupling member 320a. The other end of each of the 1-1^{th} and 1-2^{th} vibration control pads 341a and 341b may be spaced apart or separated from each other and may be in contact with the first coupling member 320a. For example, the other end of each of the 1-1^{th} and 1-2^{th} vibration control pads 341a and 341b, which are spaced apart from each other, may be in contact with the first coupling member 320a.

The other end of the 1-1^{th} vibration control pad 341a may be disposed in a region between a center of the short-side length of the vibration member 331 and the first long side of the vibration member 331. For example, when a virtual line which is parallel to the long side of the vibration apparatus 333 and passes through the center of a short-side length L2 of the vibration device 333 is referred to as a second center line CL2, the other end of the 1-1^{th} vibration control pad 341a may be disposed closer to the first long side of the vibration member 331 than the second center line CL2.

The other end of the 1-2^{th} vibration control pad 341b may be disposed in a region between the center of the short-side length of the vibration member 331 and the second long side of the vibration member 331. For example, the other end of the 1-2^{th} vibration control pad 341b may be disposed closer to the second long side of the vibration member 331 than the second center line CL2.

A length direction of each of the 1-1^{th} and 1-2^{th} vibration control pads 341a and 341b may intersect the short-side length direction (or an extension line of the short side) of the vibration apparatus 333. For example, an angle θ1 between each of the 1-1^{th} and 1-2^{th} vibration control pads 341a and 341b and the second center line CL2 may be an acute angle. For example, the angle θ1 between each of the 1-1^{th} and 1-2^{th} vibration control pads 341a and 341b and the second center line CL2 may be 37 degrees.

A length L3 of each of the 1-1^{th} and 1-2^{th} vibration control pads 341a and 341b may be shorter than an entire short-side length L2 of the vibration apparatus 333 and greater than half the entire short-side length L2 of the vibration apparatus 333. For example, the length L3 of each of the 1-1^{th} and 1-2^{th} vibration control pads 341a and 341b may be a length with respect to the center line CLL of each of the 1-1^{th} and 1-2^{th} vibration control pads 341a and 341b. For example, the length L3 of each of the 1-1^{th} and 1-2^{th} vibration control pads 341a and 341b may be ⅚ of the entire short-side length L2 of the vibration apparatus 333, but is not limited thereto.

The 1-1^{th} vibration control pad 341a and the 1-2^{th} vibration control pad 341b may be disposed symmetrically with respect to the center of the vibration apparatus 333. For example, the 1-1^{th} vibration control pad 341a and the 1-2^{th} vibration control pad 341b may be disposed (or configured) symmetrically (or vertically symmetrically) with respect to the center line (or second center line) CL2 of the short-side length of the vibration member 331 (or the vibration apparatus 333). Accordingly, the first vibration control member 341 may include a “>”-shape in a plane by the 1-1^{th} and 1-2^{th} vibration control pads 341a and 341b. For example, the 1-1^{th} and 1-2^{th} vibration control pads 341a and 341b may be configured as one structure (or one body) to include a “>”-shape in a plane.

The second vibration control member 342 may be disposed in a second short-side area SA2 adjacent to the second short side 333s2 of the vibration apparatus 333. For example, the second vibration control member 342 may be disposed in the second short-side area SA2 between the second short side 333s2 of the vibration apparatus 333 and the coupling member 320. The second vibration control member 342 may be disposed in the second short-side area SA2 to have an inclined surface (or a slope surface) which is inclined with respect to the second short side 333s2 of the vibration apparatus 333. The second vibration control member 342 may be disposed to be in contact with (or directly in contact with) the second short side 333s2 of the vibration apparatus 333. The second vibration control member 342 may be disposed to contact (or directly contact) the second coupling member 320b of the coupling member 320.

The second vibration control member 342 may include a 2-1^{th} vibration control pad 342a and a 2-2^{th} vibration control pad 342b disposed to be inclined with respect to the second short side 333s2 of the vibration apparatus 333.

Each of the 2-1^{th} and 2-2^{th} vibration control pads 342a and 342b may include a line shape (or a bar shape) having a predetermined width W1. For example, the width W1 of each of the 2-1^{th} and 2-2^{th} vibration control pads 342a and 342b may be equal to the width of the coupling member 320, but is not limited thereto. For example, the width W1 of each of the 2-1^{th} and 2-2^{th} vibration control pads 342a and 342b may be greater than the width of the coupling member 320.

Each of the 2-1^{th} and 2-2^{th} vibration control pads 342a and 342b may be disposed (or configured) to be inclined between the second coupling member 320b of the coupling member 320 and the second short side 333s2 of the vibration apparatus 333. Each of the 2-1^{th} and 2-2^{th} vibration control pads 342a and 342b may be disposed (or configured) to be in contact with the second short side 333s2 of the vibration apparatus 333 and the second coupling member 320b.

One end (or first end) of each of 2-1^{th} and 2-2^{th} vibration control pads 342a and 342b may be in contact with the second short side 333s2 of the vibration apparatus 333. The one end of each of the 2-1^{th} and 2-2^{th} vibration control pads 342a and 342b may be in contact with (or connected to) each other and may be in contact with the second short side 333s2 of the vibration apparatus 333. The one end of each of the 2-1^{th} and 2-2^{th} vibration control pads 342a and 342b, which are in contact with each other, may be in contact with the center of the second short side 333s2 of the vibration apparatus 333.

The other end (or a second end) opposite to the one end of each of 2-1^{th} and 2-2^{th} vibration control pads 342a and 342b may be in contact with the second coupling member 320b. The other end of each of the 2-1^{th} and 2-2^{th} vibration control pads 342a and 342b may be spaced apart or separated from each other and may be in contact with the second coupling member 320b. For example, the other end of each of the 2-1^{th} and 2-2^{th} vibration control pads 342a and 342b, which are spaced apart from each other, may be in contact with the second coupling member 320b.

The other end of the 2-1^{th} vibration control pad 342a may be disposed in a region between the center of the short-side length of the vibration member 331 and the first long side of the vibration member 331. For example, the other end of the 2-1^{th} vibration control pad 342a may be disposed closer to the first long side of the vibration member 331 than the second center line CL2.

The other end of the 2-2^{th} vibration control pad 342b may be disposed in a region between the center of the short-side length of the vibration member 331 and the second long side of the vibration member 331. For example, the other end of the 2-2^{th} vibration control pad 342b may be disposed closer to the second long side of the vibration member 331 than the second center line CL2.

A length direction of each of the 2-1^{th} and 2-2^{th} vibration control pads 342a and 342b may intersect the short-side length direction (or an extension line of the short side) of the vibration apparatus 333. For example, an angle θ1 between each of the 2-1^{th} and 2-2^{th} vibration control pads 342a and 342b and the second center line CL2 may be an acute angle. For example, the angle θ1 between each of the 2-1^{th} and 2-2^{th} vibration control pads 342a and 342b and the second center line CL2 may be 37 degrees.

A length L3 of each of the 2-1^{th} and 2-2^{th} vibration control pads 342a and 342b may be shorter than the entire short-side length L2 of the vibration apparatus 333 and greater than half the entire short-side length L2 of the vibration apparatus 333. For example, the length L3 of each of the 2-1^{th} and 2-2^{th} vibration control pads 342a and 342b may be the length with respect to the center line CLL of each of the 2-1^{th} and 2-2^{th} vibration control pads 342a and 342b. For example, the length L3 of each of the 2-1^{th} and 2-2^{th} vibration control pads 342a and 342b may be ⅚ of the entire short-side length L2 of the vibration apparatus 333, but is not limited thereto.

The 2-1^{th} vibration control pad 342a and the 2-2^{th} vibration control pad 342b may be disposed symmetrically with respect to the center of the vibration apparatus 333. For example, the 2-1^{th} vibration control pad 342a and the 2-2^{th} vibration control pad 342b may be disposed (or configured) symmetrically (or vertically symmetrically) with respect to the second center line CL2. Accordingly, the second vibration control member 342 may include a “<”-shape in a plane by the 2-1^{th} and 2-2^{th} vibration control pads 342a and 342b. For example, the 2-1^{th} and 2-2^{th} vibration control pads 342a and 342b may be configured as one structure (or one body) to include a “<”-shape in a plane.

The 1-1^{th} vibration control pad 341a of the first vibration control member 341 and the 2-1^{th} vibration control pad 342a of the second vibration control member 342 may be disposed (or configured) symmetrically (or horizontal symmetrically) with respect to the first center line CL1. The 1-2^{th} vibration control pad 341b of the first vibration control member 341 and the 2-2^{th} vibration control pad 342b of the second vibration control member 342 may be disposed (or configured) symmetrically (or horizontal symmetrically) with respect to the first center line CL1. For example, the 1-1^{th} vibration control pad 341a, the 1-2^{th} vibration control pad 341b, the 2-1^{th} vibration control pad 342a, and the 2-2^{th} vibration control pad 342b may be configured to have a same shape and the same size.

As described above, the vibration control member 340 or the first and second vibration control members 341 and 342 according to the first embodiment of the present disclosure may improve (or enhance) a sound characteristic and/or a sound pressure level characteristic of the low-pitched sound band (for example, 200 Hz to 1 kHz) generated based on the vibration (or displacement) of the vibration member 331 by decreasing (or suppressing) the anti-phase component which is generated around the short sides 333s1 and 333s2 of the vibration apparatus 333 based on the vibration of the vibration member 331. Therefore, the sound apparatus 30 according to an embodiment of the present disclosure may include the vibration control member 340 (or the first and second vibration control members 341 and 342), and thus, the sound characteristic and/or the sound pressure level characteristic of the low-pitched sound band may be improved (or enhanced).

FIGS. 7 to 13 are a diagram for explaining a vibration control member according to second to eighth embodiments of the present disclosure. For example, FIGS. 7 to 13 illustrate an embodiment implemented by modifying the vibration control member according to the first embodiment of the present disclosure described above with reference to FIGS. 5 and 6. In the following description, therefore, only a modified element will be described in detail, the other elements are referred to by the same reference numerals as FIGS. 5 and 6, and repeated descriptions thereof are omitted or will be briefly given. Therefore, descriptions above with reference to FIGS. 5 and 6 may be included in descriptions of FIGS. 7 to 13.

FIG. 7 illustrates an embodiment implemented by modifying an arrangement direction of each of the first and second vibration control members 341 and 342 in the vibration control member 340 according to the first embodiment of the present disclosure, in the following description, only the modified element will be described in detail.

Referring to FIG. 7, in the vibration control member 340 according to a second embodiment of the present disclosure, one end (or first end) of each of the 1-1^{th} and 1-2^{th} vibration control pads 341a and 341b of the first vibration control member 341 may be in contact with the first short side 333s1 of the vibration apparatus 333. The one end of each of the 1-1^{th} and 1-2^{th} vibration control pads 341a and 341b may be spaced apart or separated from each other and may be in contact with the first short side 333s1 of the vibration apparatus 333. For example, the one end of each of the 1-1^{th} and 1-2^{th} vibration control pads 341a and 341b, which are spaced apart from each other, may be in contact with an edge portion of the first short side 333s1 of the vibration apparatus 333. The one end of the 1-1^{th} vibration control pad 341a may be in contact with one edge portion of the first short side 333s1 of the vibration apparatus 333 adjacent to the first long side 333s3 of the vibration apparatus 333. The one end of the 1-2^{th} vibration control pad 341b may be in contact with the other edge portion of the first short side 333s1 of the vibration apparatus 333 adjacent to the second long side 333s4 of the vibration apparatus 333.

The other end (or second end) opposite to the one end of each of the 1-1^{th} and 1-2^{th} vibration control pads 341a and 341b may be in contact with the first coupling member 320a of the coupling member 320. The other end of each of the 1-1^{th} and 1-2^{th} vibration control pads 341a and 341b may be in contact with (or connected to) each other and may be in contact with the first coupling member 320a. The other end of each of the 1-1^{th} and 1-2^{th} vibration control pads 341a and 341b, which are in contact with each other, may be in contact with a center of the first coupling member 320a.

The 1-1^{th} vibration control pad 341a and the 1-2^{th} vibration control pad 341b may be disposed symmetrically with respect to the center of the vibration apparatus 333. Accordingly, the first vibration control member 341 may include a “<”-shape in a plane by the 1-1^{th} and 1-2^{th} vibration control pads 341a and 341b. For example, the 1-1^{th} and 1-2^{th} vibration control pads 341a and 341b may be configured as one structure (or one body) to include a “<”-shape in a plane.

In the vibration control member 340 according to the second embodiment of the present disclosure, one end (or first end) of each of the 2-1^{th} and 2-2^{th} vibration control pads 342a and 342b of the second vibration control member 342 may be in contact with the second short side 333s2 of the vibration apparatus 333. The one end of each of the 2-1^{th} and 2-2^{th} vibration control pads 342a and 342b may be spaced apart or separated from each other and may be in contact with the second short side 333s2 of the vibration apparatus 333. For example, the one end of each of the 2-1^{th} and 2-2^{th} vibration control pads 342a and 342b, which are spaced apart from each other, may be in contact with an edge portion of the second short side 333s2 of the vibration apparatus 333. The one end of the 2-2^{th} vibration control pad 342a may be in contact with one edge portion of the second short side 333s2 of the vibration apparatus 333 adjacent to the first long side 333s3 of the vibration apparatus 333. The one end of the 2-2^{th} vibration control pad 342b may be in contact with the other edge portion of the second short side 333s2 of the vibration apparatus 333 adjacent to the second long side 333s4 of the vibration apparatus 333.

The other end (or second end) opposite to the one end of each of the 2-1^{th} and 2-2^{th} vibration control pads 342a and 342b may be in contact with the second coupling member 320b of the coupling member 320. The other end of each of the 2-1^{th} and 2-2^{th} vibration control pads 342a and 342b may be in contact with (or connected to) each other and may be in contact with the second coupling member 320b. The other end of each of the 2-1^{th} and 2-2^{th} vibration control pads 342a and 342b, which are in contact with each other, may be in contact with a center of the second coupling member 320b.

The 2-1^{th} vibration control pad 342a and the 2-2^{th} vibration control pad 342b may be disposed symmetrically with respect to the center of the vibration apparatus 333. Accordingly, the second vibration control member 342 may include a “<”-shape in a plane by the 2-1^{th} and 2-2^{th} vibration control pads 342a and 342b. For example, the 2-1^{th} and 2-2^{th} vibration control pads 342a and 342b may be configured as one structure (or one body) to include a “<”-shape in a plane.

The 1-1^{th} vibration control pad 341a of the first vibration control member 341 and the 2-1^{th} vibration control pad 342a of the second vibration control member 342 may be disposed (or configured) symmetrically (or horizontal symmetrically) with respect to the first center line CL1. The 1-2^{th} vibration control pad 341b of the first vibration control member 341 and the 2-2^{th} vibration control pad 342b of the second vibration control member 342 may be disposed (or configured) symmetrically (or horizontal symmetrically) with respect to the first center line CL1. For example, the 1-1^{th} vibration control pad 341a, the 1-2^{th} vibration control pad 341b, the 2-1^{th} vibration control pad 342a, and the 2-2^{th} vibration control pad 342b may be configured to have a same shape and a same size.

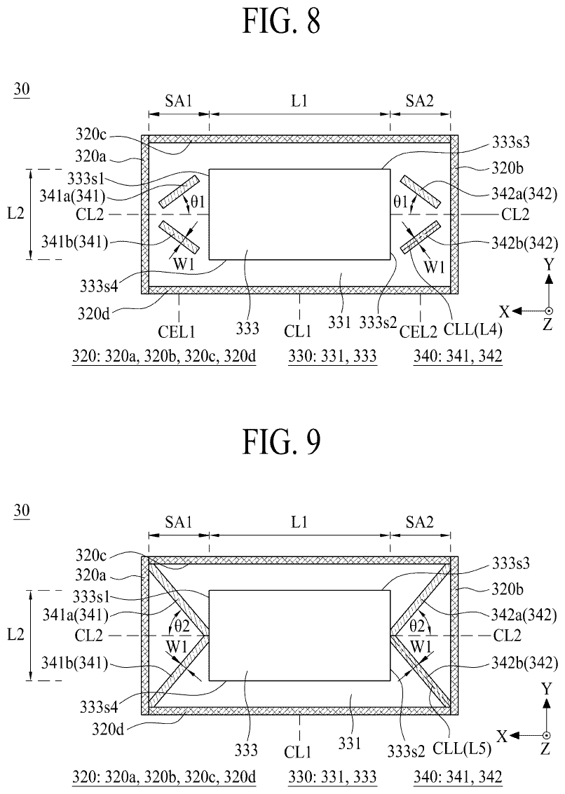

FIG. 8 illustrates an embodiment implemented by modifying a length of each of the first and second vibration control members 341 and 342 in the vibration control member 340 according to the second embodiment of the present disclosure described above with reference to FIG. 7, in the following description, only the modified element will be described in detail.

Referring to FIG. 8, in the vibration control member 340 according to a third embodiment of the present disclosure, each of the 1-1^{th} and 1-2^{th} vibration control pads 341a and 341b may be spaced apart from each of the first short side 333s1 of the vibration apparatus 333 and the coupling member 320 (or the first coupling member 320a).

Each of the one end of the 1-1^{th} and 1-2^{th} vibration control pads 341a and 341b may be spaced apart from the first short side 333s1 of the vibration apparatus 333. Accordingly, each of the one end of the 1-1^{th} and 1-2^{th} vibration control pads 341a and 341b may not contact with (or be connected to) each other and may not contact with (or be connected to) the first short side 333s1 of the vibration apparatus 333.

The other end of each of the 1-1^{th} and 1-2^{th} vibration control pads 341a and 341b may be spaced apart from the coupling member 320 (or the first coupling member 320a). Accordingly, the other end of each of the 1-1^{th} and 1-2^{th} vibration control pads 341a and 341b may not contact with (or be connected to) each other and may not contact with (or be connected to) the coupling member 320 (or the first coupling member 320a).

A length L4 of each of the 1-1^{th} and 1-2^{th} vibration control pads 341a and 341b may be equal to half the length L2/2 of the entire short-side length L2 of the vibration apparatus 333. For example, a center of each of the 1-1^{th} and 1-2^{th} vibration control pads 341a and 341b may be disposed (or aligned) on an extension line CEL1 of a center of the first short-side area SA1. Accordingly, the 1-1^{th} vibration control pad 341a and the 1-2^{th} vibration control pad 341b may be disposed symmetrically (or vertically symmetrically) with respect to the center (or the second center line CL2) of the vibration apparatus 333.

In the vibration control member 340 according to the third embodiment of the present disclosure, each of the 2-1^{th} and 2-2^{th} vibration control pads 342a and 342b may be spaced apart from the second short side 333s2 of the vibration apparatus 333 and the coupling member 320 (or the second coupling member 320b).

Each of one end of the 2-1^{th} and 2-2^{th} vibration control pads 342a and 342b may be spaced apart from the second short side 333s2 of the vibration apparatus 333. Accordingly, each of the one end of the 2-1^{th} and 2-2^{th} vibration control pads 342a and 342b may not contact with (or be connected to) each other and may not contact with (or be connected to) the second short side 333s2 of the vibration apparatus 333.

The other end of each of the 2-1^{th} and 2-2^{th} vibration control pads 342a and 342b may be spaced apart from the coupling member 320 (or the second coupling member 320b). Accordingly, the other end of each of the 2-1^{th} and 2-2^{th} vibration control pads 342a and 342b may not contact with (or be connected to) each other and may not contact with (or be connected to) the coupling member 320 (or the second coupling member 320b).

A length L4 of each of the 2-1^{th} and 2-2^{th} vibration control pads 342a and 342b may be equal to half the length L2/2 of the entire short-side length L2 of the vibration apparatus 333. For example, a center of each of the 2-1^{th} and 2-2^{th} vibration control pads 342a and 342b may be disposed (or aligned) on an extension line CEL2 of a center of the second short-side area SA2. Accordingly, the 2-1^{th} vibration control pad 342a and the 2-2^{th} vibration control pad 342b may be disposed symmetrically (or vertically symmetrically) with respect to the center (or the second center line CL2) of the vibration apparatus 333.

The 1-1^{th} vibration control pad 341a of the first vibration control member 341 and the 2-1^{th} vibration control pad 342a of the second vibration control member 342 may be disposed (or configured) symmetrically (or horizontal symmetrically) with respect to the first center line CL1. The 1-2^{th} vibration control pad 341b of the first vibration control member 341 and the 2-2^{th} vibration control pad 342b of the second vibration control member 342 may be disposed (or configured) symmetrically (or horizontal symmetrically) with respect to the first center line CL1. For example, the 1-1^{th} vibration control pad 341a, the 1-2^{th} vibration control pad 341b, the 2-1^{th} vibration control pad 342a, and the 2-2^{th} vibration control pad 342b may be configured to have a same shape and a same size.

FIG. 9 illustrates an embodiment implemented by modifying a length and an arrangement position of each of the first and second vibration control members 341 and 342 in the vibration control member 340 according to the second embodiment of the present disclosure described above with reference to FIG. 7, in the following description, only the modified element will be described in detail.

Referring to FIG. 9, in the vibration control member 340 according to a fourth embodiment of the present disclosure, one end (or first end) of each of the 1-1^{th} and 1-2^{th} vibration control pads 341a and 341b may be in contact with the first short side 333s1 of the vibration apparatus 333. The one end of each of the 1-1^{th} and 1-2^{th} vibration control pads 341a and 341b may be in contact with (or connected to) each other and may be in contact with a center of the first short side 333s1 of the vibration apparatus 333.

The other end of each of the 1-1^{th} and 1-2^{th} vibration control pads 341a and 341b are spaced apart or separated from each other and may be in contact with the coupling member 320. The other end of the 1-1^{th} vibration control pad 341a may be in contact with a first corner portion of the coupling member 320 where the first coupling member 320a and the third coupling member 320c are connected. The other end of the 1-2^{th} vibration control pad 341b may be in contact with a fourth corner portion of the coupling member 320 where the first coupling member 320a and the fourth coupling member 320d are connected.

A length L5 of each of the 1-1^{th} and 1-2^{th} vibration control pads 341a and 341b may be longer than the entire short-side length L2 of the vibration apparatus 333 and shorter than the long-side length L1 of the vibration apparatus 333.

An angle θ2 between each of the 1-1^{th} and 1-2^{th} vibration control pads 341a and 341b and the second center line CL2 may be an acute angle. For example, the angle θ2 between each of the 1-1^{th} and 1-2^{th} vibration control pads 341a and 341b and the second center line CL2 may be 48 degrees or more and 52 degrees or less. The 1-1^{th} vibration control pad 341a and the 1-2^{th} vibration control pad 341b may be disposed symmetrically (or vertically symmetrically) with respect to the center (or the second center line CL2) of the vibration apparatus 333. Accordingly, the first vibration control member 341 may include a “>”-shape in a plane by the 1-1^{th} and 1-2^{th} vibration control pads 341a and 341b. For example, the 1-1^{th} and 1-2^{th} vibration control pads 341a and 341b may be configured as one structure (or one body) to include a “>”-shape in a plane.

In the vibration control member 340 according to the fourth embodiment of the present disclosure, one end (or first end) of each of the 2-1^{th} and 2-2^{th} vibration control pads 342a and 342b may be in contact with the second short side 333s2 of the vibration apparatus 333. The one end of each of the 2-1^{th} and 2-2^{th} vibration control pads 342a and 342b may be in contact with (or connected to) each other and may be in contact with a center of the second short side 333s2 of the vibration apparatus 333.

The other end of each of the 2-1^{th} and 2-2^{th} vibration control pads 342a and 342b are spaced apart or separated from each other and may be in contact with the coupling member 320. The other end of the 2-1^{th} vibration control pad 342a may be in contact with a second corner portion of the coupling member 320 where the second coupling member 320b and the third coupling member 320c are connected. The other end of the 2-2^{th} vibration control pad 342b may be in contact with a third corner portion of the coupling member 320 where the second coupling member 320b and the fourth coupling member 320d are connected.

A length L5 of each of the 2-1^{th} and 2-2^{th} vibration control pads 342a and 342b may be longer than the entire short-side length L2 of the vibration apparatus 333 and shorter than the long-side length L2 of the vibration apparatus 333.

An angle θ2 between each of the 2-1^{th} and 2-2^{th} vibration control pads 342a and 342b and the second center line CL2 may be an acute angle. For example, the angle θ2 between each of the 2-1^{th} and 2-2^{th} vibration control pads 342a and 342b and the second center line CL2 may be 48 degrees or more and 52 degrees or less. The 2-1^{th} vibration control pad 342a and the 2-2^{th} vibration control pad 342b may be disposed symmetrically (or vertically symmetrically) with respect to the center of the vibration apparatus 333 (or the second center line CL2). Accordingly, the second vibration control member 342 may include a “<”-shape in a plane by the 2-1^{th} and 2-2^{th} vibration control pads 342a and 342b. For example, the 2-1^{th} and 2-2^{th} vibration control pads 342a and 342b may be configured as one structure (or one body) to include a “<”-shape in a plane.

The 1-1^{th} vibration control pad 341a of the first vibration control member 341 and the 2-1^{th} vibration control pad 342a of the second vibration control member 342 may be disposed (or configured) symmetrically (or horizontal symmetrically) with respect to the first center line CL1. The 1-2^{th} vibration control pad 341b of the first vibration control member 341 and the 2-2^{th} vibration control pad 342b of the second vibration control member 342 may be disposed (or configured) symmetrically (or horizontal symmetrically) with respect to the first center line CL1. For example, the 1-1^{th} vibration control pad 341a, the 1-2^{th} vibration control pad 341b, the 2-1^{th} vibration control pad 342a, and the 2-2^{th} vibration control pad 342b may be configured to have a same shape and a same size.

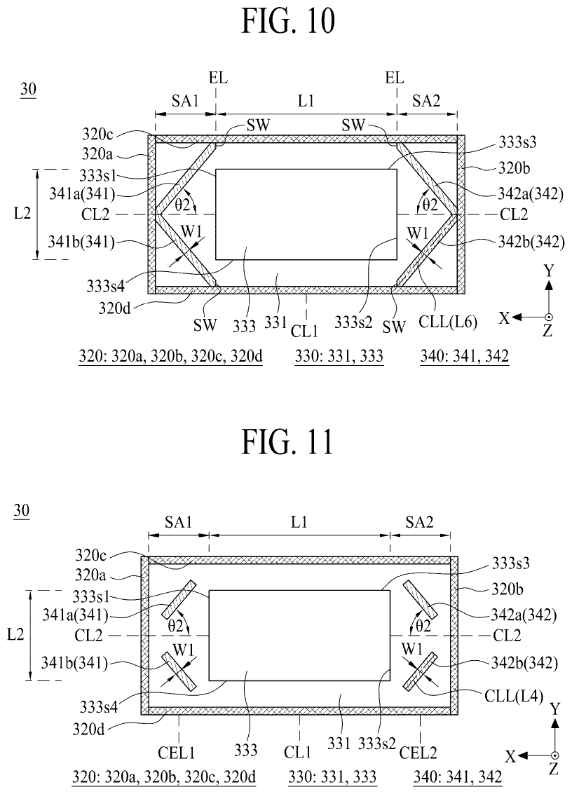

FIG. 10 illustrates an embodiment implemented by modifying an arrangement direction of each of the first and second vibration control members 341 and 342 in the vibration control member 340 according to the fourth embodiment of the present disclosure described above with reference to FIG. 9, in the following description, only the modified element will be described in detail.

Referring to FIG. 10, in the vibration control member 340 according to a fifth embodiment of the present disclosure, the first vibration control member 341 may be disposed (or configured) to be spaced apart from the first short side 333s1 of the vibration apparatus 333 and to surround the first short side 333s1 of the vibration apparatus 333. The first vibration control member 341 may be in contact with the coupling member 320. For example, the first vibration control member 341 may be disposed (or configured) to be in contact with the first coupling member 320a, the third coupling member 320c, and the fourth coupling member 320d of the coupling member 320.

The 1-1^{th} vibration control pad 341a of the first vibration control member 341 may be spaced apart from the first short side 333s1 of the vibration apparatus 333 and may be disposed (or configured) to be inclined (or at an inclined angle) between the first coupling member 320a and the third coupling member 320c. One end of the 1-1^{th} vibration control pad 341a may be in contact with the third coupling member 320c. For example, the one end of the 1-1^{th} vibration control pad 341a may be disposed only within the first short side area SA1. For example, a sidewall SW of the one end of the 1-1^{th} vibration control pad 341a may be aligned with the extension line EL of the first short side 333s1 of the vibration apparatus 333. The other end of the 1-1^{th} vibration control pad 341a may be in contact with the first coupling member 320a. For example, the other end of the 1-1^{th} vibration control pad 341a may be in contact with a center of the first coupling member 320a.

The 1-2^{th} vibration control pad 341b of the first vibration control member 341 may be spaced apart from the first short side 333s1 of the vibration apparatus 333 and may be disposed (or configured) to be inclined between the first coupling member 320a and the fourth coupling member 320d. One end of the 1-2^{th} vibration control pad 341b may be in contact with the fourth coupling member 320d. For example, the one end of the 1-2^{th} vibration control pad 341b may be disposed only within the first short side area SA1. For example, a sidewall SW of the one end of the 1-2^{th} vibration control pad 341b may be aligned with the extension line EL of the first short side 333s1 of the vibration apparatus 333. The other end of the 1-2^{th} vibration control pad 341b may be in contact with the first coupling member 320a. For example, the other end of the 1-2^{th} vibration control pad 341b may be in contact with the center of the first coupling member 320a.

The other end of each of the 1-1^{th} and 1-2^{th} vibration control pads 341a and 341b may be in contact with (or connected to) each other and may be in contact with the center of the first coupling member 320a.

A length L6 of each of the 1-1^{th} and 1-2^{th} vibration control pads 341a and 341b may be longer than an entire short-side length L2 of the vibration apparatus 333 and shorter than the long-side length L1 of the vibration apparatus 333.

An angle θ2 between each of the 1-1^{th} and 1-2^{th} vibration control pads 341a and 341b and the second center line CL2 may be an acute angle. For example, the angle θ2 between each of the 1-1^{th} and 1-2^{th} vibration control pads 341a and 341b and the second center line CL2 may be 48 degrees or more and 52 degrees or less. The 1-1^{th} vibration control pad 341a and the 1-2^{th} vibration control pad 341b may be disposed symmetrically (or vertically symmetrically) with respect to the center (or the second center line CL2) of the vibration apparatus 333. Accordingly, the first vibration control member 341 may include a “<”-shape in a plane by the 1-1^{th} and 1-2^{th} vibration control pads 341a and 341b. For example, the 1-1^{th} and 1-2^{th} vibration control pads 341a and 341b may be configured as one structure (or one body) to include a “<”-shape in a plane.

In the vibration control member 340 according to the fifth embodiment of the present disclosure, the second vibration control member 342 may be disposed (or configured) to be spaced apart from the second short side 333s2 of the vibration apparatus 333 and to surround the second short side 333s2 of the vibration apparatus 333. The second vibration control member 342 may be in contact with the coupling member 320. For example, the second vibration control member 342 may be disposed (or configured) to be in contact with the second coupling member 320b, the third coupling member 320c, and the fourth coupling member 320d of the coupling member 320.

The 2-1^{th} vibration control pad 342a of the second vibration control member 342 may be spaced apart from the second short side 333s2 of the vibration apparatus 333 and may be disposed (or configured) to be inclined between the second coupling member 320b and the third coupling member 320c. One end of the 2-1^{th} vibration control pad 342a may be in contact with the third coupling member 320c. For example, the one end of the 2-1^{th} vibration control pad 342a may be disposed only within the second short side area SA2. For example, a sidewall SW of the one end of the 2-1^{th} vibration control pad 342a may be aligned with the extension line EL of the second short side 333s2 of the vibration apparatus 333. The other end of the 2-1^{th} vibration control pad 342a may be in contact with the second coupling member 320b. For example, the other end of the 2-1^{th} vibration control pad 342a may be in contact with the center of the second coupling member 320b.

The 2-2^{th} vibration control pad 342b of the second vibration control member 342 may be spaced apart from the second short side 333s2 of the vibration apparatus 333 and may be disposed (or configured) to be inclined between the second coupling member 320b and the fourth coupling member 320d. One end of the 2-2^{th} vibration control pad 342b may be in contact with the fourth coupling member 320d. For example, the one end of the 2-2^{th} vibration control pad 342b may be disposed only within a second short side area SA2. For example, a sidewall SW of the one end of the 2-2^{th} vibration control pad 342b may be aligned with the extension line EL of the second short side 333s2 of the vibration apparatus 333. The other end of the 2-2^{th} vibration control pad 342b may be in contact with the second coupling member 320b. For example, the other end of the 2-2^{th} vibration control pad 342b may be in contact with the center of the second coupling member 320b.

The other end of each of the 2-1^{th} and 2-2^{th} vibration control pads 342a and 342b may be in contact with (or connected to) each other and may be in contact with the center of the second coupling member 320b.

A length L6 of each of the 2-1^{th} and 2-2^{th} vibration control pads 342a and 342b may be longer than an entire short-side length L2 of the vibration apparatus 333 and shorter than the long-side length L1 of the vibration apparatus 333.

An angle θ2 between each of the 2-1^{th} and 2-2^{th} vibration control pads 342a and 342b and the second center line CL2 may be an acute angle. For example, the angle θ2 between each of the 2-1^{th} and 2-2^{th} vibration control pads 342a and 342b and the second center line CL2 may be 48 degrees or more and 52 degrees or less. The 2-1^{th} vibration control pad 342a and the 2-2^{th} vibration control pad 342b may be disposed symmetrically (or vertically symmetrically) with respect to the center of the vibration apparatus 333 (or the second center line CL2). Accordingly, the second vibration control member 342 may include a “>”-shape in a plane by the 2-1^{th} and 2-2^{th} vibration control pads 342a and 342b. For example, the 2-1^{th} and 2-2^{th} vibration control pads 342a and 342b may be configured as one structure (or one body) to include a “>”-shape in a plane.

The 1-1^{th} vibration control pad 341a of the first vibration control member 341 and the 2-1^{th} vibration control pad 342a of the second vibration control member 342 may be disposed (or configured) symmetrically (or horizontal symmetrically) with respect to the first center line CL1. The 1-2^{th} vibration control pad 341b of the first vibration control member 341 and the 2-2^{th} vibration control pad 342b of the second vibration control member 342 may be disposed (or configured) symmetrically (or horizontal symmetrically) with respect to the first center line CL1. For example, the 1-1^{th} vibration control pad 341a, the 1-2^{th} vibration control pad 341b, the 2-1^{th} vibration control pad 342a, and the 2-2^{th} vibration control pad 342b may be configured to have a same shape and a same size.

FIG. 11 illustrates an embodiment implemented by modifying a length of each of the first and second vibration control members 341 and 342 in the vibration control member 340 according to the fifth embodiment of the present disclosure described above with reference to FIG. 10, in the following description, only the modified element will be described in detail.

Referring to FIG. 11, in the vibration control member 340 according to a sixth embodiment of the present disclosure, each of the 1-1^{th} and 1-2^{th} vibration control pads 341a and 341b may be spaced apart from each of the first short side 333s1 of the vibration apparatus 333 and the coupling member 320.

One end of the 1-1^{th} vibration control pad 341a may be spaced apart from each of the first short side 333s1 of the vibration apparatus 333 and the third coupling member 320c. The other end of the 1-1^{th} vibration control pad 341a may be spaced apart from the first coupling member 320a.

One end of the 1-2^{th} vibration control pad 341b may be spaced apart from each of the first short side 333s1 of the vibration apparatus 333 and the fourth coupling member 320d. The other end of the 1-2^{th} vibration control pad 341b may be spaced apart from the first coupling member 320a.

A length L4 of each of the 1-1^{th} and 1-2^{th} vibration control pads 341a and 341b may be equal to half the length L2/2 of the entire short-side length L2 of the vibration apparatus 333. For example, a center of each of the 1-1^{th} and 1-2^{th} vibration control pads 341a and 341b may be disposed (or aligned) on an extension line CEL1 of a center of the first short-side area SA1. Accordingly, the 1-1^{th} vibration control pad 341a and the 1-2^{th} vibration control pad 341b may be disposed symmetrically (or vertically symmetrically) with respect to the center (or the second center line CL2) of the vibration apparatus 333.

In the vibration control member 340 according to the sixth embodiment of the present disclosure, each of the 2-1^{th} and 2-2^{th} vibration control pads 342a and 342b may be spaced apart from each of the second short side 333s2 of the vibration apparatus 333 and the coupling member 320.

One end of the 2-1^{th} vibration control pad 342a may be spaced apart from each of the second short side 333s2 of the vibration apparatus 333 and the third coupling member 320c. The other end of the 2-1^{th} vibration control pad 342a may be spaced apart from the second coupling member 320b.

One end of the 2-2^{th} vibration control pad 342b may be spaced apart from each of the second short side 333s2 of the vibration apparatus 333 and the fourth coupling member 320d. The other end of the 2-2^{th} vibration control pad 342b may be spaced apart from the second coupling member 320b.

A length L4 of each of the 2-1^{th} and 2-2^{th} vibration control pads 342a and 342b may be equal to half the length L2/2 of an entire short-side length L2 of the vibration apparatus 333. For example, a center of each of the 2-1^{th} and 2-2^{th} vibration control pads 342a and 342b may be disposed (or aligned) on an extension line CEL2 of a center of the second short-side area SA2. Accordingly, the 2-1^{th} vibration control pad 342a and the 2-2^{th} vibration control pad 342b may be disposed symmetrically (or vertically symmetrically) with respect to the center (or the second center line CL2) of the vibration apparatus 333.

The 1-1^{th} vibration control pad 341a of the first vibration control member 341 and the 2-1^{th} vibration control pad 342a of the second vibration control member 342 may be disposed (or configured) symmetrically (or horizontal symmetrically) with respect to the first center line CL1. The 1-2^{th} vibration control pad 341b of the first vibration control member 341 and the 2-2^{th} vibration control pad 342b of the second vibration control member 342 may be disposed (or configured) symmetrically (or horizontal symmetrically) with respect to the first center line CL1. For example, the 1-1^{th} vibration control pad 341a, the 1-2^{th} vibration control pad 341b, the 2-1^{th} vibration control pad 342a, and the 2-2^{th} vibration control pad 342b may be configured to have a same shape and a same size.

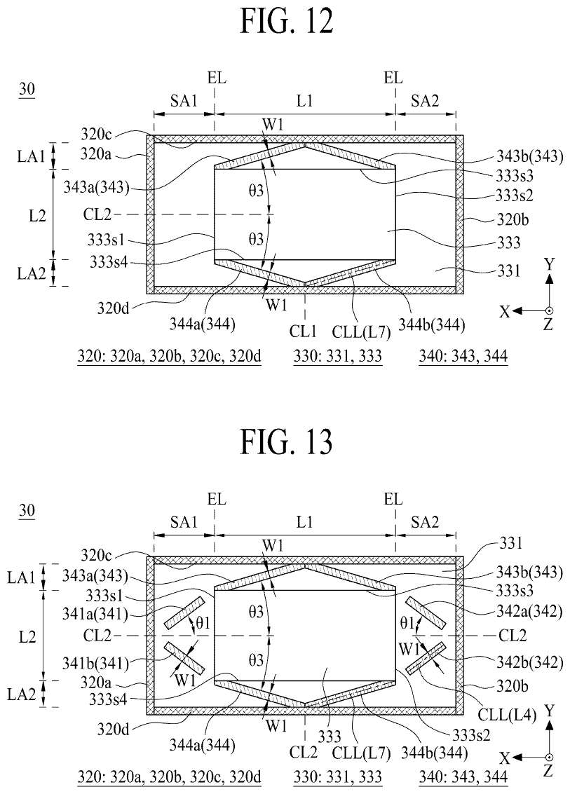

FIG. 12 is a diagram illustrating a vibration control member according to a seventh embodiment of the present disclosure.

Referring to FIGS. 5 and 12, the vibration control member 340 according to the seventh embodiment of the present disclosure may include a third vibration control member 343 and a fourth vibration control member 344.

Each of the third and fourth vibration control elements 343 and 344 may have a height corresponding to a distance between the enclosure 310 (or plate 311) and the vibration element 331.

The third vibration control member 343 and the fourth vibration control member 344 may be disposed (or configured) symmetrically (or vertically symmetrically) with respect to a center of the vibration member 331 (or the vibration apparatus 333. For example, the third vibration control member 343 and the fourth vibration control member 344 may be disposed (or configured) symmetrically (or vertically symmetrically) with respect to the second center line CL2.

The third vibration control member 343 may be disposed in a first long-side area LA1 adjacent to the first long side 333s3 of the vibration apparatus 333. For example, the third vibration control member 343 may be disposed in the first long-side area LA1 between the first long side 333s3 of the vibration apparatus 333 and the coupling member 320. The third vibration control member 343 may be disposed in the first long-side area LA1 to have an inclined surface (or a slope surface) which is inclined with respect to the first long side 333s3 of the vibration apparatus 333. The third vibration control member 343 may be disposed to be in contact (or directly in contact) with the first long side 333s3 of the vibration apparatus 333. The third vibration control member 343 may be disposed to be in contact (or directly in contact) with the third coupling member 320c of the coupling member 320.

The third vibration control member 343 may include a 3-1^{th} vibration control pad 343a and a 3-2^{th} vibration control pad 343b disposed to be inclined with respect to the first long side 333s3 of the vibration apparatus 333.

Each of the 3-1^{th} and 3-2^{th} vibration control pads 343a and 343b may include a line shape (or a bar shape) having a predetermined width W1. For example, the width W1 of each of the 3-1^{th} and 3-2^{th} vibration control pads 343a and 343b may be equal to a width of the coupling member 320, but is not limited thereto. For example, the width W1 of each of the 3-1^{th} and 3-2^{th} vibration control pads 343a and 343b may be greater than the width of the coupling member 320.

Each of the 3-1^{th} and 3-2^{th} vibration control pads 343a and 343b may be disposed (or configured) to be inclined between the third coupling member 320c of the coupling member 320 and the first long side 333s3 of the vibration apparatus 333. Each of the 3-1^{th} and 3-2^{th} vibration control pads 343a and 343b may be disposed (or configured) to be in contact with the first long side 333s3 of the vibration apparatus 333 and the third coupling member 320c.

One end (or first end) of each of the 3-1^{th} and 3-2^{th} vibration control pads 343a and 343b may be in contact with the first long side 333s3 of the vibration apparatus 333. The one end of each of the 3-1^{th} and 3-2^{th} vibration control pads 343a and 343b may be spaced apart or separated from each other and may be in contact with the first long side 333s3 of the vibration apparatus 333. For example, the one end of each of the 3-1^{th} and 3-2^{th} vibration control pads 343a and 343b, which are spaced apart from each other, may be in contact with an edge portion of the first long side 333s3 of the vibration apparatus 333. For example, the one end of the 3-1^{th} vibration control pad 343a may be in contact with one edge portion of the first long side 333s3 of the vibration apparatus 333 adjacent to the first short side 333s1 of the vibration apparatus 333. One end of the 3-2^{th} vibration control pad 343b may be in contact with the other edge portion of the first long side 333s3 of the vibration apparatus 333 adjacent to the second short side 333s2 of the vibration apparatus 333.

The one end of the 3-1^{th} vibration control pad 343a may be disposed only within the first long side area LA1. For example, a sidewall of the one end of the 3-1^{th} vibration control pad 343a may be aligned with an extension line EL of the first short side 333s1 of the vibration apparatus 333. The one end of the 3-2^{th} vibration control pad 343b may be disposed only within the first long side area LA1. For example, a sidewall of the one end of the 3-2^{th} vibration control pad 343b may be aligned with an extension line EL of the second short side 333s2 of the vibration apparatus 333.

The other end (or second end) opposite to the one end of each of the 3-1^{th} and 3-2^{th} vibration control pads 332a and 343b may be in contact with the third coupling member 320c. The other end of each of the 3-1^{th} and 3-2^{th} vibration control pads 332a and 343b may be in contact with (or connected to) each other and may be in contact with the third coupling member 320c. The other end of each of the 3-1^{th} and 3-2^{th} vibration control pads 332a and 343b, which are in contact with each other, may be in contact with a center of the third coupling member 320c.

A length direction of each of the 3-1^{th} and 3-2^{th} vibration control pads 343a and 343b may intersect the long-side length direction (or an extension line of the long side) of the vibration apparatus 333. For example, an angle θ3 between each of the 3-1^{th} and 3-2^{th} vibration control pads 343a and 343b and the second center line CL2 may be an acute angle. For example, the angle θ3 between each of the 3-1^{th} and 3-2^{th} vibration control pads 343a and 343b and the second center line CL2 may be 16 degrees.

A length L7 of each of the 3-1^{th} and 3-2^{th} vibration control pads 343a and 343b may be shorter than an entire long-side length L1 of the vibration apparatus 333 and greater than half the length the entire short-side length L2 of the vibration apparatus 333. For example, the length L7 of each of the 3-1^{th} and 3-2^{th} vibration control pads 343a and 343b may be a length with respect to the center line CLL of each of the 3-1^{th} and 3-2^{th} vibration control pads 343a and 343b.

The 3-1^{th} vibration control pad 343a and the 3-2^{th} vibration control pad 343b may be disposed symmetrically with respect to the center of the vibration apparatus 333. For example, the 3-1^{th} vibration control pad 343a and the 3-2^{th} vibration control pad 343b may be disposed (or configured) symmetrically (or horizontal symmetrically) with respect to the first center line CL1. Accordingly, the third vibration control member 343 may include a “∧”-shape in a plane by the 3-1^{th} and 3-2^{th} vibration control pads 343a and 343b. For example, the 3-1^{th} and 3-2^{th} vibration control pads 343a and 343b may be configured as one structure (or one body) to include a “∧”-shape in a plane.

The fourth vibration control member 344 may be disposed in a second long-side area LA2 adjacent to the second long side 333s4 of the vibration apparatus 333. For example, the fourth vibration control member 344 may be disposed in the second long-side area LA2 between the second long side 333s4 of the vibration apparatus 333 and the coupling member 320. The fourth vibration control member 344 may be disposed in the second long-side area LA2 to have an inclined surface (or a slope surface) which is inclined with respect to the second long side 333s4 of the vibration apparatus 333. The fourth vibration control member 344 may be disposed to be in contact (or directly in contact) with the second long side 333s4 of the vibration apparatus 333. The fourth vibration control member 344 may be disposed to be in contact (or directly in contact) with the fourth coupling member 320d of the coupling member 320.

The fourth vibration control member 344 may include a 4-1^{th} vibration control pad 344a and a 4-2^{th} vibration control pad 344b disposed to be inclined with respect to the second long side 333s4 of the vibration apparatus 333.

Each of the 4-1^{th} and 4-2^{th} vibration control pads 344a and 344b may include a line shape (or a bar shape) having a predetermined width W1. For example, the width W1 of each of the 4-1^{th} and 4-2^{th} vibration control pads 344a and 344b may be equal to a width of the coupling member 320, but is not limited thereto. For example, the width W1 of each of the 4-1^{th} and 4-2^{th} vibration control pads 344a and 344b may be greater than the width of the coupling member 320.

Each of the 4-1^{th} and 4-2^{th} vibration control pads 344a and 344b may be disposed (or configured) to be inclined between the fourth coupling member 320d of the coupling member 320 and the second long side 333s4 of the vibration apparatus 333. Each of the 4-1^{th} and 4-2^{th} vibration control pads 344a and 344b may be disposed (or configured) to be in contact with the second long side 333s4 of the vibration apparatus 333 and the fourth coupling member 320d.

One end (or first end) of each of the 4-1^{th} and 4-2^{th} vibration control pads 344a and 344b may be in contact with the second long side 333s4 of the vibration apparatus 333. The one end of each of the 4-1^{th} and 4-2^{th} vibration control pads 344a and 344b may be spaced apart or separated from each other and may be in contact with the second long side 333s4 of the vibration apparatus 333. For example, the one end of each of the 4-1^{th} and 4-2^{th} vibration control pads 344a and 344b, which are spaced apart from each other, may be in contact with an edge portion of the second long side 333s4 of the vibration apparatus 333. For example, the one end of the 4-1^{th} vibration control pad 344a may be in contact with one edge portion of the second long side 333s4 of the vibration apparatus 333 adjacent to the first short side 333s1 of the vibration apparatus 333. The one end of the 4-2^{th} vibration control pad 344b may be in contact with the other edge portion of the second long side 333s4 of the vibration apparatus 333 adjacent to the second short side 333s2 of the vibration apparatus 333.

The one end of the 4-1^{th} vibration control pad 344a may be disposed only within the second long side area LA2. For example, a sidewall of the one end of the 4-1^{th} vibration control pad 344a may be aligned with an extension line EL of the first short side 333s1 of the vibration apparatus 333. The one end of the 4-2^{th} vibration control pad 344b may be disposed only within the second long side area LA2. For example, a sidewall of the one end of the 4-2^{th} vibration control pad 344b may be aligned with an extension line EL of the second short side 333s2 of the vibration apparatus 333.

The other end (or second end) opposite to the one end of each of the 4-1^{th} and 4-2^{th} vibration control pads 344a and 344b may be in contact with the fourth coupling member 320d. The other end of each of the 4-1^{th} and 4-2^{th} vibration control pads 344a and 344b may be in contact with (or connected to) each other and may be in contact with the fourth coupling member 320d. The other end of each of the 4-1^{th} and 4-2^{th} vibration control pads 344a and 344b, which are in contact with each other, may be in contact with a center of the fourth coupling member 320d.

A length direction of each of the 4-1^{th} and 4-2^{th} vibration control pads 344a and 344b may intersect the long-side length direction (or an extension line of the long side) of the vibration apparatus 333. For example, an angle θ3 between each of the 4-1^{th} and 4-2^{th} vibration control pads 344a and 344b and the second center line CL2 may be an acute angle. For example, the angle θ3 between each of the 4-1^{th} and 4-2^{th} vibration control pads 344a and 344b and the second center line CL2 may be 16 degrees.

A length L7 of each of the 4-1^{th} and 4-2^{th} vibration control pads 344a and 344b may be shorter than the entire long-side length L1 of the vibration apparatus 333 and greater than half the length the entire short-side length L2 of the vibration apparatus 333. For example, the length L7 of each of the 4-1^{th} and 4-2^{th} vibration control pads 344a and 344b may be the length with respect to the center line CLL of each of the 4-1^{th} and 4-2^{th} vibration control pads 344a and 344b.

The 4-1^{th} vibration control pad 344a and the 4-2^{th} vibration control pad 344b may be disposed symmetrically with respect to the center of the vibration apparatus 333. For example, the 4-1^{th} vibration control pad 344a and the 4-2^{th} vibration control pad 344b may be disposed (or configured) symmetrically (or horizontal symmetrically) with respect to the first center line CL1. Accordingly, the fourth vibration control member 344 may include a “∨”-shape in a plane by the 4-1^{th} and 4-2^{th} vibration control pads 344a and 344b. For example, the 4-1^{th} and 4-2^{th} vibration control pads 344a and 344b may be configured as one structure (or one body) to include a “∨”-shape in a plane.

The 3-1^{th} vibration control pad 343a of the third vibration control member 343 and the 4-1^{th} vibration control pad 344a of the fourth vibration control member 344 may be disposed (or configured) symmetrically (or vertically symmetrically) with respect to the second center line CL2. The 3-2^{th} vibration control pad 343b of the third vibration control member 343 and the 4-2^{th} vibration control pad 344b of the fourth vibration control member 344 may be disposed (or configured) symmetrically (or vertically symmetrically) with respect to the second center line CL2. For example, the 3-1^{th} vibration control pad 343a, the 3-2^{th} vibration control pad 343b, the 4-1^{th} vibration control pad 344a, and the 4-2^{th} vibration control pad 344b may be configured to have a same shape and a same size.

As described above, the vibration control member 340 or the third and fourth vibration control members 343 and 344 according to the seventh embodiment of the present disclosure may improve (or enhance) a sound characteristic and/or a sound pressure level characteristic of the low-pitched sound band (for example, 200 Hz to 1 kHz) generated based on the vibration (or displacement) of the vibration member 331 by decreasing (or suppressing) the anti-phase component which is generated around the long sides 333s3 and 333s4 of the vibration apparatus 333 based on the vibration of the vibration member 331. Therefore, the sound apparatus 30 according to an embodiment of the present disclosure may include the vibration control member 340 (or the third and fourth vibration control members 343 and 344), and thus, the sound characteristic and/or the sound pressure level characteristic of the low-pitched sound band may be improved (or enhanced).

FIG. 13 is a diagram illustrating a vibration control member according to an eighth embodiment of the present disclosure. FIG. 13 illustrates an embodiment where the third and fourth vibration control members described above with reference to FIG. 12 are additionally configured at the sound apparatus described above with reference to FIG. 8, in the following description, only the modified element will be described in detail.

Referring to FIG. 13, the vibration control member 340 according to an eighth embodiment of the present disclosure may include first to fourth vibration control members 341, 342, 343, and 344.

The first vibration control member 341 may be disposed in the first short-side area SA1 to have an inclined surface (or a slope surface) which is inclined with respect to the first short side 333s1 of the vibration apparatus 333. The first vibration control member 341 may include a 1-1^{th} vibration control pad 341a and a 1-2^{th} vibration control pad 341b disposed to be inclined with respect to the first short side 333s1 of the vibration apparatus 333. The first vibration control member 341 may be substantially a same as the first vibration control member 341 described above with reference to FIG. 8, and the repetitive description thereof may be omitted.

The second vibration control member 342 may be disposed in the second short-side area SA2 to have an inclined surface (or a slope surface) which is inclined with respect to the second short side 333s2 of the vibration apparatus 333. The second vibration control member 342 may include a 2-1^{th} vibration control pad 342a and a 2-2^{th} vibration control pad 342b disposed to be inclined with respect to the second short side 333s2 of the vibration apparatus 333. The second vibration control member 342 may be substantially a same as the second vibration control member 342 described above with reference to FIG. 8, and the repetitive description thereof may be omitted.

The third vibration control member 343 may be disposed in the first long-side area LA1 to have an inclined surface (or a slope surface) which is inclined with respect to the first long side 333s3 of the vibration apparatus 333. The third vibration control member 343 may include a 3-1^{th} vibration control pad 343a and a 3-2^{th} vibration control pad 343b disposed to be inclined with respect to the third long side 333s3 of the vibration apparatus 333. The third vibration control member 343 may be substantially a same as the third vibration control member 343 described above with reference to FIG. 12, and the repetitive description thereof may be omitted.

The fourth vibration control member 344 may be disposed in the second long-side area LA2 to have an inclined surface (or a slope surface) which is inclined with respect to the second long side 333s4 of the vibration apparatus 333. The fourth vibration control member 344 may include a 4-1^{th} vibration control pad 344a and a 4-2^{th} vibration control pad 344b disposed to be inclined with respect to the second long side 333s4 of the vibration apparatus 333. The fourth vibration control member 344 may be substantially a same as the fourth vibration control member 344 described above with reference to FIG. 12, and the repetitive description thereof may be omitted.

As described above, the vibration control member 340 or the first to fourth vibration control members 341, 342, 343, and 344 according to the eighth embodiment of the present disclosure may improve (or enhance) a sound characteristic and/or a sound pressure level characteristic of the low-pitched sound band (for example, 200 Hz to 1 kHz) generated based on the vibration (or displacement) of the vibration member 331 by decreasing (or suppressing) the anti-phase component which is generated around the short sides 333s1 and 333s2 and the long sides 333s3 and 333s4 of the vibration apparatus 333 based on the vibration of the vibration member 331. Therefore, the sound apparatus 30 according to an embodiment of the present disclosure may include the vibration control member 340 (or the first to fourth vibration control members 341, 342, 343, and 344), and thus, the sound characteristic and/or the sound pressure level characteristic of the low-pitched sound band may be improved (or enhanced).

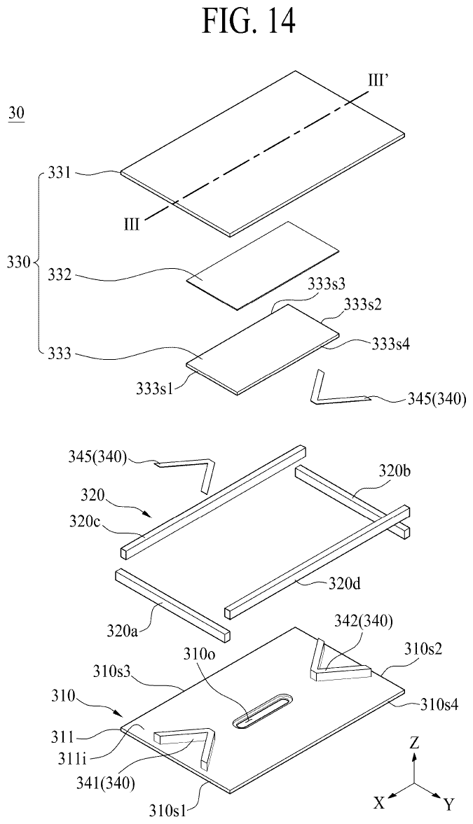

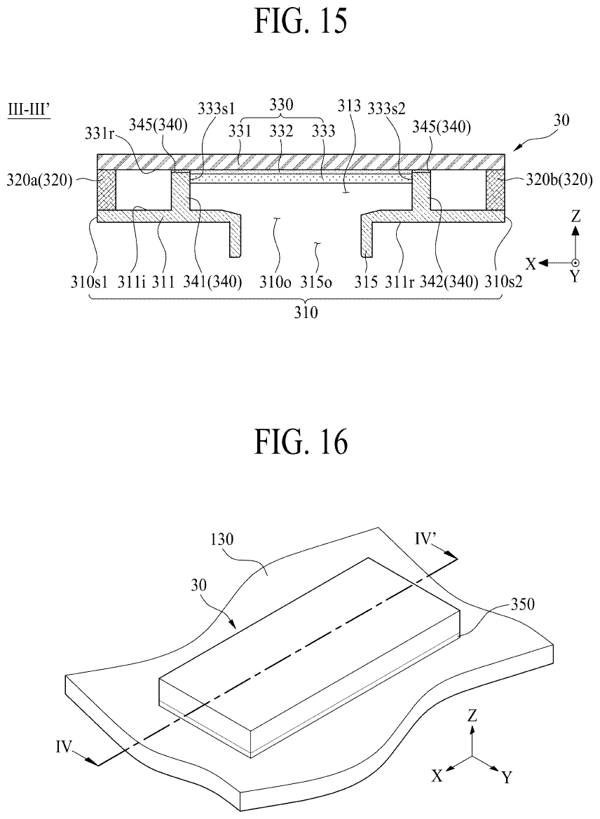

FIG. 14 is an exploded perspective view illustrating a sound apparatus according to another embodiment of the present disclosure. FIG. 15 is a cross-sectional view taken along III-III′ illustrated in FIG. 14 according to one embodiment. For example, FIGS. 14 and 15 illustrate an embodiment implemented by modifying the vibration control member in the sound apparatus described above with reference to FIGS. 2 to 6. In the following description, therefore, the vibration control member will be described in detail, the other elements may be same as or substantially a same as that of descriptions described above with reference to FIGS. 2 to 6, and thus, like reference numerals refer to like elements and their repetitive descriptions are omitted or will be briefly given below. Therefore, descriptions above with reference to FIGS. 2 to 6 may be included in descriptions of FIGS. 14 and 15.

Referring to FIGS. 14 and 15, in a sound apparatus 30 (or a sound apparatus for a vehicle) according to another embodiment of the present disclosure, a vibration control member 340 may be integrated with an enclosure 310 (or a plate 311) described above with reference to FIGS. 2 to 11. The vibration control member 34 and the enclosure 310 (or the plate 311) may be configured as one body (or one element). For example, the enclosure 310 (or the plate 311) may be configured to include the vibration control member 340. For example, the vibration control member 34 may be a rib, a supporting portion, a protrusion portion, or a boss.

The vibration control member 340 according to another embodiment of the present disclosure may include a first vibration control member 341 and a second vibration control member 342.

The vibration control member 340 (or the first and second vibration control members 341 and 342) may protrude from the inner surface 311i of the enclosure 310 (or the plate 311) to one side (or a rear surface) 331r of the vibration member 331.

The vibration control member 340 (or the first and second vibration control members 341 and 342) may be made of a same material (or substance) as the enclosure 310 (or the plate 311), but is not limited thereto. For example, the vibration control member 340 (or the first and second vibration control members 341 and 342) and the enclosure 310 (or the plate 311) may be made of different materials.

As an embodiment, the vibration control member 340 (or the first and second vibration control members 341 and 342) and the enclosure 310 (or the plate 311) may be an injection material which is implemented by an injection process using different plastic materials. As another embodiment, the vibration control member 340 (or the first and second vibration control members 341 and 342) and the enclosure 310 (or the plate 311) may be an injection material which is implemented by an injection process using a metal material and a plastic material, in this case, the vibration control member 340 (or the first and second vibration control members 341 and 342) may be made of one of the metal material and the plastic material, and the enclosure 310 (or the plate 311) may be made of a material different from the vibration control member 340 of the metal material and the plastic material.

The vibration control member 340 (or the first and second vibration control members 341 and 342) and the enclosure 310 (or the plate 311) may be connected or coupled to the one side (or rear surface) 331r of the vibration member 331 by an adhesive member 345.

Except for that the vibration control member 340 (or the first and second vibration control members 341 and 342) protrudes from the inner surface 311i of the enclosure 310 (or the plate 311), the vibration control member 340 (or the first and second vibration control members 341 and 342) may be substantially a same as the vibration control member 340 (or the first and second vibration control members 341 and 342) described above with reference to FIGS. 2 to 11, and thus, like reference numerals refer to like elements and their repetitive descriptions are omitted. Therefore, descriptions of the vibration control member 340 (or the first and second vibration control members 341 and 342) described above with reference to FIGS. 2 to 11 may be included in descriptions of FIGS. 14 and 15. For example, in the vibration control member 340 (or the first and second vibration control members 341 and 342) described above with reference to FIGS. 2 to 11, the 1-1^{th} and 1-2^{th} vibration control pads 341a and 341b of the first vibration control member 341 and the 2-1^{th} and 2-2^{th} vibration control pads 342a and 342b of the second vibration control member 342 may protrude from an inner surface 311i of the enclosure 310 (or the plate 311) to include a “>”-shape or “<”-shape in a plane.

As described above, the vibration control member 340 (or the first and second vibration control members 341 and 342) which is integrated (or configured) in the enclosure 310 (or the plate 311) may improve (or enhance) a sound characteristic and/or a sound pressure level characteristic of the low-pitched sound band (for example, 200 Hz to 1 kHz) generated based on the vibration (or displacement) of the vibration member 331 by decreasing (or suppressing) the anti-phase component which is generated around the short sides 333s1 and 333s2 of the vibration apparatus 333 based on the vibration of the vibration member 331.

Therefore, the sound apparatus 30 according to another embodiment of the present disclosure may have a same effect as the sound apparatus 30 described above with reference to FIGS. 2 to 6. In addition, since the sound apparatus 30 according to another embodiment of the present disclosure includes a vibration control member 340 integrated (or configured) in the enclosure 310, the vibration control member 340 may be easily connected or coupled to the vibration member 331, and thus, a connection process or coupling process between the vibration control member 340 and the vibration member 331 may be simplified.

The vibration control member 340 described above with reference to FIGS. 14 and 15 may be identically applied to the vibration control member 340 (or the third and fourth vibration control members 343 and 344) described above with reference to FIG. 12. For example, the vibration control member 340 (or the third and fourth vibration control members 343 and 344) described above with reference to FIG. 12 may protrude from an inner surface 311i of the enclosure 310 (or the plate 311) and may be connected or coupled to one surface (or a rear surface) 331r of the vibration member 331 by an adhesive member 345, and thus, their repetitive descriptions are omitted. For example, in the vibration control member 340 described above with reference to FIG. 12, the 3-1^{th} and 3-2^{th} vibration control pads 343a and 343b of the third vibration control member 343 and the 4-1^{th} and 4-2^{th} vibration control pads 344a and 344b of the fourth vibration control member 344 may protrude from the inner surface 311i of the enclosure 310 (or plate 311) to include a “∨”-shape or “∧”-shape in a plane.

The vibration control member 340 described above with reference to FIGS. 14 and 15 may be identically applied to the vibration control member 340 (or the first to fourth vibration control members 341, 342, 343, and 344) described above with reference to FIG. 12. For example, the vibration control member 340 (or the first to fourth vibration control members 341, 342, 343, and 344) described above with reference to FIG. 12 may protrude from the inner surface 311i of the enclosure 310 (or the plate 311) and may be connected or coupled to one surface (or rear surface) 331r of the vibration member 331 by an adhesive member 345, and thus, their repetitive descriptions are omitted. For example, in the vibration control member 340 described above with reference to FIG. 12, the 1-1^{th} and 1-2^{th} vibration control pads 341a and 341b of the first vibration control member 341 and the 2-1^{th} and 2-2^{th} vibration control pads 342a and 342b of the second vibration control member 342 may protrude from the inner surface 311i of the enclosure 310 (or the plate 311) to include a “>”-shape or “<”-shape in a plane. For example, in the vibration control member 340 described above with reference to FIG. 12, the 3-1^{th} and 3-2^{th} vibration control pads 343a and 343b of the third vibration control member 343 and the 4-1^{th} and 4-2^{th} vibration control pads 344a and 344b of the fourth vibration control member 344 may protrude from the inner surface 311i of the enclosure 310 (or plate 311) to include a “∨”-shape or “∧”-shape in a plane.

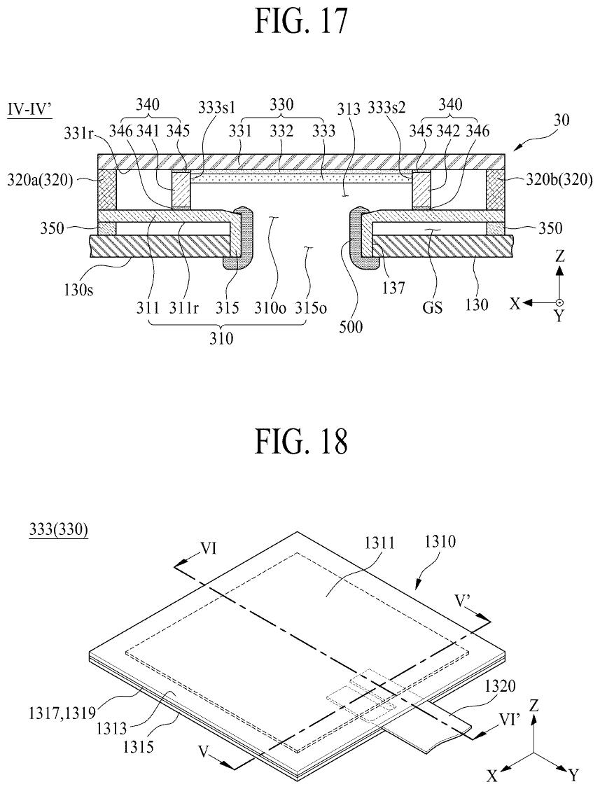

FIG. 16 is a diagram illustrating a sound apparatus according to another embodiment of the present disclosure. FIG. 17 is a cross-sectional view taken along IV-IV′ illustrated in FIG. 16 according to one embodiment of the present disclosure.

Referring to FIGS. 16 and 17, the sound apparatus 30 according to another embodiment of the present disclosure may be connected or coupled (or mounted) to a vehicle interior material (or mount object) 130 by using a connection member 350.

The sound apparatus 30 may include an enclosure 310, a coupling member 320, a sound generating module 330, and a vibration control member 340. Descriptions of each of the enclosure 310, the coupling member 320, the sound generating module 330, and the vibration control member 340 may be substantially a same as that of descriptions described above with reference to FIGS. 2 to 15, and thus, like reference numerals refer to like elements and their repetitive descriptions are omitted or will be briefly given below. Therefore, descriptions of the sound apparatus 30 described above with reference to FIGS. 2 to 15 may be included in the description of FIGS. 16 and 17.

The vehicle interior material 130 may be connected or coupled to the connection member 350 in the sound apparatus 30. For example, the vehicle interior material 130 may be connected or coupled to the enclosure 310 (or a plate 311) by the connection member 350. The connection member 350 may be disposed (or interposed) between the sound apparatus 30 and the vehicle interior material 130. For example, the connection member 350 may be disposed (or interposed) between the enclosure 310 (or the plate 311) and the vehicle interior material 130.

The vehicle interior material 130 may include a first surface and a second surface which is different from (or opposite to) the first surface. The first surface may be a surface facing the enclosure 370. The vehicle interior material 130 may further include a hole 137. For example, the hole 137 of the vehicle interior material 130 may be configured to penetrate through the first surface and the second surface.

The hole 137 may correspond to (or overlap) an opening portion 310o configured at the enclosure 310 (or plate 311). The hole 137 may have a size which is a same as or greater than the opening portion 310o. The hole 137 may correspond to (or overlap) an opening hole (or a hollow hole) 315o of a protrusion portion 315 configured at the enclosure 310 (or plate 311). The hole 137 may have a size which is a same as or greater than the opening hole 315o of the protrusion portion 315. For example, the hole 137 may be a through hole, an opening portion, an opening hole, a slit, a slot, a sound hole, a sound emission hole, or a sound output hole, but is not limited thereto.

The hole 137 may be configured to accommodate (or receive) a portion (or an end portion) of the protrusion portion 315. The portion (or end portion) of the protrusion portion 315 may be accommodated or inserted into the hole 137 of the vehicle interior material 130. Therefore, a sound generated (or output) by vibration of the vibration member 331 due to vibration of the vibration apparatus 333 configured in the sound apparatus 30 may be output to an interior space of the vehicle through the opening hole 315o of the protrusion portion 315 and the hole 137 of the vehicle interior material 130.

According to an embodiment, the connection member 350 may be connected to (or interposed) between an edge portion of a rear surface 311r of the enclosure 310 (or the plate 311) and the vehicle interior material 130. Accordingly, the connection member 350 may provide a gap space GS between a middle portion of the enclosure 310 (or the plate 311) and the vehicle interior material 130. The vehicle interior material 130 may be connected (or coupled) to only the edge portion of the rear surface 311r of the enclosure 310 (or the plate 311) through the connection member 350.

According to an embodiment, the connection member 350 is made of a relatively stiffer material (or a hard material), and thus, may transfer the vibration of the enclosure 310 (or the plate 311) to the vehicle interior material 130. For example, the enclosure 310 (or the plate 311) may vibrate by sound (or sound wave or sound pressure) generated in the resonance space 313 based on the vibration of the vibration member 331 due to the vibration of the vibration apparatus 333. For example, the vibration of the enclosure 310 (or the plate 311) may be transferred to the vehicle interior material 130 through the connection member 350. Accordingly, the vehicle interior material 130 may vibrate based on the vibration transferred through the connection member 350 to generate the sound. For example, when the connection member 350 is composed of the relatively stiffer material (or hard material), the vehicle interior material 130 which is connected to the connection member 350 may be a vibration plate for generating (or outputting) a sound. For example, when the connection member 350 is composed of the relatively stiffer material (or hard material), the vibration of the enclosure 310 (or plate 311) may be transmitted to the vehicle interior material 130 more efficiently.

The sound apparatus 30 according to another embodiment of the present disclosure may further include a coupling part 500. The coupling part 500 may be configured to fix (or secure) the enclosure 310 (or a plate 311) which is mounted (or attached) to the vehicle interior material 130. For example, the coupling part 500 may be connected (or coupled) or fastened to the protrusion portion 315 (or enclosure 310 or plate 311) through the hole 137 of the vehicle interior material 130 in an interior space of the vehicle. For example, the coupling part 500 may be connected (or coupled) or fastened to the protrusion portion 315 (or enclosure 310 or plate 311) by a hook coupling method. Accordingly, the coupling part 500 may be easily connected or coupled to the protrusion portion 315, and thus, a connection process or coupling process between the vehicle interior material 130 and the sound apparatus 30 may be simplified.

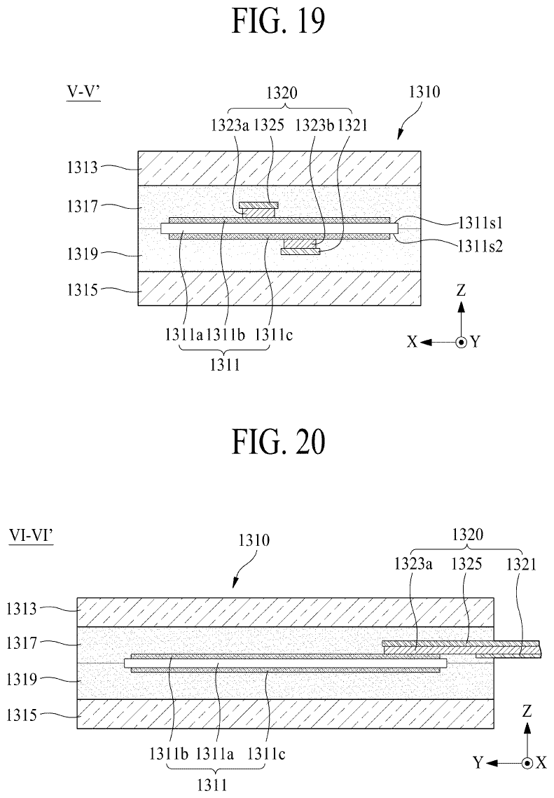

FIG. 18 is a diagram illustrating a vibration apparatus according to an embodiment of the present disclosure. FIG. 19 is a cross-sectional view taken along V-V′ illustrated in FIG. 18 according to an embodiment of the present disclosure. FIG. 20 is a cross-sectional view taken along VI-VI′ illustrated in FIG. 18 according to an embodiment of the present disclosure.

Referring to FIGS. 18 to 20, in a sound generation module 330 of the sound apparatus according to an embodiment of the present disclosure, a vibration apparatus 333 may include one or more vibration generators 1310. The vibration apparatus 333 may include a vibration generator 1310.

The vibration generator 1310 may include a piezoelectric material having a piezoelectric characteristic. The vibration generator 1310 may vibrate (or displace or drive) a vibration member based on vibration (or displacement or driving) of the piezoelectric material by an electric signal (or a voice signal or a sound signal) applied to the piezoelectric material. For example, the vibration generator 1310 may be a vibration generation device, a vibration generation film, a film actuator, a film exciter, an ultrasonic actuator, or an active vibration member, or the like, but is not limited thereto.

The vibration generator 1310 according to an embodiment of the present disclosure may include a vibration generating part 1311.

The vibration generating part 1311 may be configured to vibrate based on the piezoelectric effect by a driving signal. For example, the vibration generating part 1311 may include a piezoelectric type vibration part. The vibration generating part 1311 may include one or more of a piezoelectric inorganic material and a piezoelectric organic material. For example, the vibration generating part 1311 may be a vibration device, a piezoelectric device, a piezoelectric structure, or a piezoelectric vibration layer, or the like, but is not limited thereto.

The vibration generating part 1311 according to an embodiment may include a vibration part 1311a, a first electrode part 1311b, and a second electrode part 1311c.

The vibration part 1311a may include a piezoelectric material or an electroactive material which includes a piezoelectric effect. For example, the vibration part 1311a may be a piezoelectric layer, a piezoelectric material layer, an electroactive layer, a piezoelectric composite layer, or a piezoelectric ceramic composite, or the like, but is not limited thereto.

The vibration part 1311a may be configured as a ceramic-based material or may be configured as a piezoelectric ceramic having a perovskite-based crystalline structure. The piezoelectric ceramic may be configured as a single crystalline ceramic having a crystalline structure or may be configured as a ceramic material having a polycrystalline structure or polycrystalline ceramic.

The first electrode part 1311b may be disposed at a first surface (or a front surface) 1311s1 of the vibration part 1311a. The second electrode part 1311c may be disposed at a second surface (or a rear surface) 1311s2 which is opposite to or different from the first surface 1311s1 of the vibration part 1311a.

The vibration part 1311a may be polarized (or poling) by a certain voltage applied to the first electrode part 1311b and the second electrode part 1311c in a certain temperature atmosphere, or a temperature atmosphere that may be changed from a high temperature to a room temperature, but is are not limited thereto. The vibration part 1311a may alternately and repeatedly contract and/or expand by an inverse piezoelectric effect based on a driving signal applied to the first electrode part 1311b and the second electrode part 1311c from the outside to vibrate.

The vibration generator 1310 according to an embodiment may further include a first cover member 1313 and a second cover member 1315.

The first cover member 1313 may be configured to have a larger size than the vibration generating part 1311. The first cover member 1313 may be configured to protect the first surface of the vibration generating part 1311 and the first electrode part 1311b. The second cover member 1315 may be configured to have a greater size than the vibration generating part 1311 and may be configured to have a same size as the first cover member 1313. The second cover member 1315 may be configured to protect the second surface of the vibration generating part 1311 and the second electrode part 1311c.

The first cover member 1313 and the second cover member 1315 may include a same material or a different material. For example, each of the first cover member 1313 and the second cover member 1315 may be a plastic film, but is not limited thereto.

The first cover member 1313 may be connected or coupled to the first surface of the vibration generating part 1311 or the first electrode part 1311b by using a first adhesive layer 1317. The second cover member 1315 may be connected or coupled to the second surface of the vibration generating part 1311 or the second electrode part 1311c by a second adhesive layer 1319.

Each of the first adhesive layer 1317 and second adhesive layer 1319 may include an electrically insulating material which has adhesiveness and is capable of compression and decompression. The first adhesive layer 1317 and second adhesive layer 1319 may be configured between the first cover member 1313 and the second cover member 1315 to surround the vibration generating part 1311. For example, one or more of the first adhesive layer 1317 and second adhesive layer 1319 may be configured to partially or completely surround the vibration generating part 1311.

Any one of the first cover member 1313 and the second cover member 1315 may be connected or coupled to the rear surface 331r of the vibration member 331 by using the adhesive member 332 illustrated in FIGS. 4, 5, 15, and 17.

Any one of the first cover member 1313 and the second cover member 1315 may be omitted. For example, any one of the first cover member 1313 and the second cover member 1315 may be configured to cover or protect one or more of the first surface and the second surface of the vibration generator 1310.

The vibration generator 1310 according to an embodiment of the present disclosure may further include a signal supply member 1320.

The signal supply member 1320 may be configured to be electrically connected to the vibration part 1311a. The signal supply member 1320 may be configured to be electrically connected to the first electrode part 1311b and the second electrode part 1311c of the vibration generating part 1311.

A portion of the signal supply member 1320 may be accommodated (or inserted) between the first cover member 1313 and the second cover member 1315. An end portion (or a distal end portion or one side) of the signal supply member 1320 may be disposed or inserted (or accommodated) between one edge portion (or one periphery portion) of the first cover member 1313 and one edge portion (or one periphery portion) of the second cover member 1315. Accordingly, the signal supply member 1320 may be integrated as one body with the vibration generating part 1311. Accordingly, the sound generating module 330 or the vibration apparatus 333 may be implemented in a film type integrated with the signal supply member 1320. For example, the signal supply member 1320 may be configured as one part (or one component) with the vibration generating part 1311, thereby realizing an effect of uni-materialization.

The signal supply member 1320 according to an embodiment of the present disclosure may include a base member 1321 and a plurality of signal lines 1323a and 1323b. For example, the signal supply member 1320 may include a base member 1321, a first signal line 1323a, and a second signal line 1323b.

The base member 1321 may have a certain width along a first direction X and may be extended long along a second direction Y intersecting with the first direction X.

The first signal line 1323a and the second signal line 1323b may be disposed at the first surface of the base member 1321 in parallel with the second direction Y and may be spaced apart from each other or electrically separated from each other along the first direction X. For example, the first signal line 1323a and the second signal line 1323b may be implemented in a line shape by patterning of a metal layer (or a conductive layer) formed or deposited at the first surface of the base member 1321.

End portions (or distal end portions or one sides) of the first signal line 1323a and the second signal line 1323b may be separated from each other, and thus, may be individually curved or bent.

The end portion (or the distal end portion or the one side) of the first signal line 1323a may be electrically connected to (or in contact with) at least a portion of the first electrode part 1311b of the vibration generating part 1311 in the one edge portion of the first cover member 1313. For example, the end portion of the first signal line 1323a may be electrically connected to the first electrode part 1311b by a conductive double-sided tape. Accordingly, the first signal line 1323a may be configured to transfer a first driving signal, supplied from a driving circuit part, to the first electrode part 1311b of the vibration generating part 1311.

The end portion (or the distal end portion or the one side) of the second signal line 1323b may be electrically connected to (or in contact with) at least a portion of the second electrode part 1311c of the vibration generating part 1311 in the one edge portion of the second cover member 1315. For example, the end portion of the second signal line 1323b may be electrically connected to the second electrode part 1311c by a conductive double-sided tape. Accordingly, the second signal line 1323b may be configured to transfer a second driving signal, supplied from the driving circuit part, to the second electrode part 1311c of the vibration generating part 1311.

The signal supply member 1320 according to an embodiment may further include an insulation layer 1325.

The insulation layer 1325 may be disposed at the first surface of the base member 1321 to cover each of the first signal line 1323a and the second signal line 1323b other than the end portion (or one side) of the signal supply member 1320.

An end portion (or one side) of the signal supply member 1320 including an end portion (or one side) of the base member 1321 and an end portion (or one side) 1325a of the insulation layer 1325 may be inserted (or accommodated) between the first cover member 1313 and the second cover member 1315 and may be fixed between the first cover member 1313 and the second cover member 1315 by a first adhesive layer 1317 and the second adhesive layer 1319. Accordingly, the end portion (or one side) of the first signal line 1323a may be maintained with being electrically connected to the first electrode part 1311b of the vibration generating part 1311, and the end portion (or one side) of the second signal line 1323b may be maintained with being electrically connected to the second electrode part 1311c of the vibration generating part 1311. In addition, the end portion (or one side) of the signal supply member 1320 may be inserted (or accommodated) and fixed between the vibration generating part 1311 and the first cover member 1313, and thus, a contact defect between the vibration generator 1310 and the signal supply member 1320 caused by the movement of the signal supply member 1320 may be prevented.

According to an embodiment of the present disclosure, the first signal line 1323a and the second signal line 1323b of the signal supply member 1320 may be integrated as one body with the vibration generator 1310, and thus, a soldering process for an electrical connection between the vibration generator 1310 and the signal supply member 1320 may not be needed. Accordingly, a manufacturing process and a structure of the vibration apparatus 333 may be simplified, and hazards associated with the soldering process may be reduced.

The vibration part 1311a according to another embodiment of the present disclosure may include a piezoelectric composite having flexible characteristics, but is not limited thereto. For example, the vibration part 1311a including the piezoelectric composite may implement a sound apparatus having flexible characteristics.

According to an embodiment, the piezoelectric composite of the vibration part 1311a may include a plurality of piezoelectric material portions (or inorganic material portions), and a plurality of organic material portions (or flexible portions) configured to fill gaps between the plurality of piezoelectric material portions. For example, the plurality of piezoelectric material portions and the plurality of organic material portions may include a line shape or a stripe shape which has a same or different sizes, but is not limited thereto.

According to another embodiment, the piezoelectric composite of the vibration part 1311a may include a plurality of piezoelectric material portions (or inorganic material portions), and an organic material portion (or a flexible material portion) disposed between the plurality of piezoelectric material portions. For example, each of the plurality of piezoelectric material portions may have a hexahedral shape and may be disposed in a lattice shape, but is not limited thereto. For example, each of the plurality of piezoelectric material portions may have circular shape plate, an oval shape plate, or a polygonal shape plate. For example, the organic material portion may be configured to fill a gap between two adjacent piezoelectric material portions of the plurality of piezoelectric material portions or to surround each of the plurality of piezoelectric material portions, and thus, the organic material portion may be connected to or attached on the piezoelectric material portions adjacent thereto.

The plurality of piezoelectric material portions and the organic material portion may be disposed on (or connected to) a same plane, and thus, the vibration part 1311a according to another embodiment of the present disclosure may have a single thin film-type. Accordingly, the vibration generating part 1311 or the vibration generator 1310 including the vibration part 1311a according to another embodiment of the present disclosure may vibrate by the piezoelectric material portions having a vibration characteristic and may be bent in a curved shape by the organic material portion having flexibility.

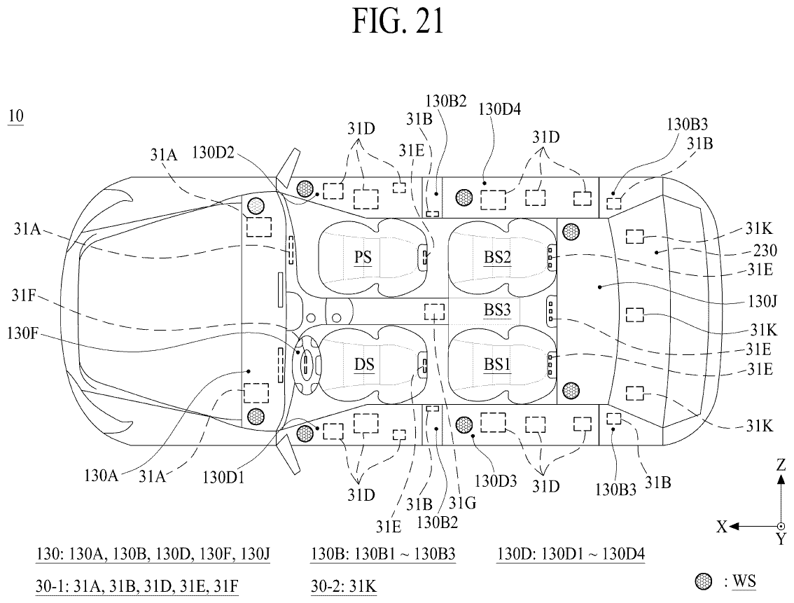

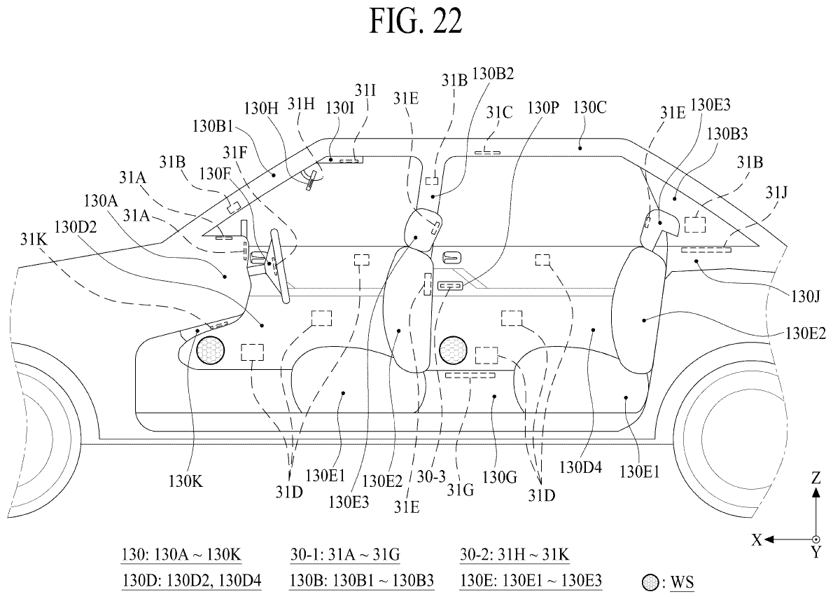

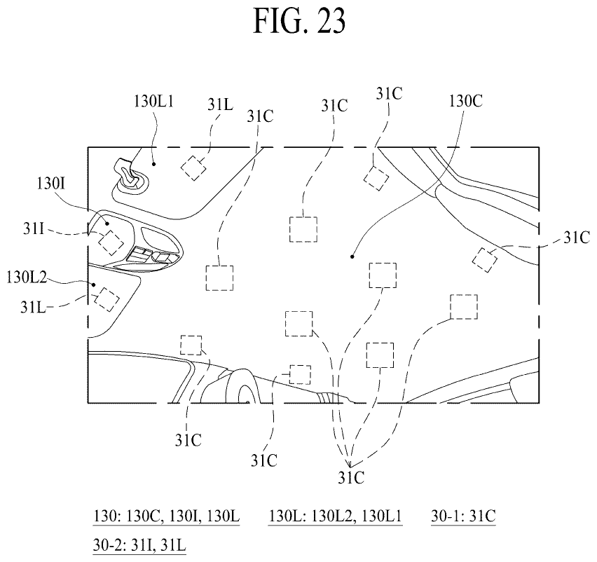

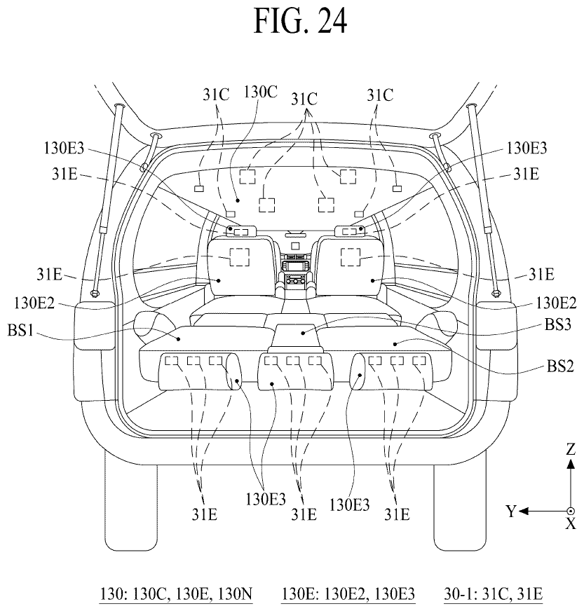

FIG. 21 is a diagram illustrating a vehicular apparatus according to an embodiment of the present disclosure. FIG. 22 is a diagram illustrating a vehicular apparatus according to an embodiment of the present disclosure. FIG. 23 is a diagram illustrating a sound generating apparatus disposed at a roof of a vehicular apparatus illustrated in FIGS. 21 and 22. FIG. 24 is a diagram illustrating a sound generating apparatus disposed at a roof and a seat of a vehicular apparatus illustrated in FIGS. 21 and 22.

Referring to FIGS. 21 to 24, a vehicular apparatus 10 according to an embodiment of the present disclosure may include a vehicle interior material 130 and a first sound generating apparatuses 30-1. For example, the vehicle interior material 130 may output sound based on vibration of one or more first sound generating apparatuses 30-1. For example, the vehicle interior material 130 may be exposed to an interior space (or an indoor space).

The first sound generating apparatus 30-1 may include one or more sound generators 31A to 31G which are disposed at one or more of a dashboard 130A, a pillar interior material 130B, a roof interior material 130C, a door interior material 130D, a seat interior material 130E, a handle interior material 130F, and a floor interior material 130G. For example, the first sound generating apparatus 30-1 may include one or more of first to seventh sound generators 31A to 31G, and thus, may output sounds of one or more channels.

The one or more of first to seventh sound generators 31A to 31G may include the sound apparatus 30 described above with reference to FIGS. 2 to 20, and thus, the repetitive descriptions are omitted.

The first sound generator 31A may be disposed between a dash panel and the dashboard 130A and configured to output sound into the interior space. Furthermore, the first sound generator 31A may be configured to indirectly or directly vibrate the dashboard 130A to output sound based on a vibration of the dashboard 130A.

One or more of the dash panel and the dashboard 130A may include a first region corresponding to a driver seat DS, a second region corresponding to a passenger seat PS, and a third region (or a middle region) between the first region and the second region. One or more of the dash panel and the dashboard 130A may include a fourth region which is inclined to face the passenger seat PS. The first sound generator 31A may be disposed (or configured) in one or more of the first to fourth regions of the dashboard 130. For example, one or more of the first to fourth regions of the dashboard 130A may include a hole to accommodate a protrusion portion in an enclosure of a sound apparatus 30 configuring the first sound generator 31A.

The second sound generator 31B may be disposed between a pillar panel and the pillar interior material 130B and configured to output sound into the interior space. Furthermore, the second sound generator 31B may be configured to indirectly or directly vibrate the pillar interior material 130B to output sound based on a vibration of the pillar interior material 130B.

The pillar panel may include a first pillar (or an A pillar) disposed at both sides of a front window, a second pillar (or a B pillar) disposed at both sides of a center of a vehicle body, and a third pillar (or a C pillar) disposed at both sides of a rear portion of the vehicle body. The pillar interior material 130B may include a first pillar interior material 130B1 covering the first pillar, a second pillar interior material 130B2 covering the second pillar, and a third pillar interior material 130B3 covering the third pillar. The second sound generator 31B may be disposed (or configured) in one or more of the first to third pillar interior materials 130B1, 130B2, and 130B3. For example, one or more of the first to third pillar interior materials 130B1, 130B2, and 130B3 may include a hole to accommodate a protrusion portion in an enclosure of a sound apparatus 30 configuring the second sound generator 31B.

Referring to FIGS. 21 to 23, the third sound generator 31C may be disposed between a roof frame (or a roof panel) and the roof interior material 130C and configured to output sound into the interior space. Furthermore, the third sound generator 31C may be configured to indirectly or directly vibrate the roof interior material 130C and output sound based on a vibration of the roof interior material 130C.

The roof interior material 130C may include the first region corresponding to the driver seat DS, the second region corresponding to the passenger seat PS, a third region corresponding to a region between the driver seat DS and the passenger seat PS, a fourth region corresponding to a first rear seat BS1 behind the driver seat DS, a fifth region corresponding to a second rear seat BS2 behind the passenger seat PS, a sixth region corresponding to a region between the first rear seat BS1 and the second rear seat BS2, and a seventh region between the third region and the sixth region. For example, the third sound generator 31C may be disposed (or configured) in one or more of the first to seventh regions of the roof interior material 130C. For example, one or more of the first to seventh regions of the loop interior material 130C may include a hole to accommodate a protrusion portion in an enclosure of a sound apparatus 30 configuring the roof interior material 130C.

Referring to FIGS. 21 and 22, the fourth sound generator 31D may be disposed between a door frame and the door interior material 130D and configured to output sound into the interior space. Furthermore, the fourth sound generator 31D may be configured to indirectly or directly vibrate the door interior material 130D and output sound based on a vibration of the door interior material 130D.

One or more of the door frame and the door interior material 130D may include an upper region, a middle region, and a lower region with respect to a height direction Z of the vehicular apparatus 10. For example, the fourth sound generator 31D may be disposed (or configured) at one or more of the upper region, the middle region, and the lower region of the door interior material 130D. For example, one or more of the upper region, the middle region, and the lower region of the door interior material 130D may include a hole to accommodate a protrusion portion in an enclosure of a sound apparatus 30 configuring the roof interior material 130C.

The door frame may include a first door frame (or a left front door frame), a second door frame (or a right front door frame), a third door frame (or a left rear door frame), and a fourth door frame (or a right rear door frame). According to an embodiment of the present disclosure, the door interior material 130D may include a first door interior material (or a left front door interior material) 130D1 covering the first door frame, a second door interior material (or a right front door interior material) 130D2 covering the second door frame, a third door interior material (or a left rear door interior material) 130D3 covering the third door frame, and a fourth door interior material (or a right rear door interior material) 130D4 covering the fourth door frame. For example, the fourth sound generator 31D may be disposed (or configured) at one or more of the upper region, the middle region, and the lower region between each of the first to fourth door frames and the first to fourth door interior materials 130D1, 130D2, 130D3, and 130D4.

The fourth sound generator 31D configured to vibrate one or more of the middle region and the lower region of one or more of the first to fourth door interior materials 130D1, 130D2, 130D3, and 130D4 may be one or more of a woofer, a mid-woofer, and a sub-woofer.

The upper region of each of the first to fourth door interior materials 130D1, 130D2, 130D3, and 130D4 may include a first upper region adjacent to the dashboard 130A, a second upper region adjacent to the rear seats BS1, BS2, and BS3, and a third upper region between the first upper region and the second upper region. For example, the fourth sound generator 31D may be disposed (or configured) at one or more of the first to third upper regions of one or more among the first to fourth door interior materials 130D1, 130D2, 130D3, and 130D4. For example, one or more of the first to third upper regions of one or more among the first to fourth door interior materials 130D1, 130D2, 130D3, and 130D4 may include a hole to accommodate a protrusion portion in an enclosure of a sound apparatus 30 configuring the fourth sound generator 31D.

Referring to FIGS. 21, 22, and 24, the fifth sound generator 31E may be disposed between a seat frame and the seat interior material 130E and configured to output sound into the interior space. Furthermore, the fifth sound generator 31E may be configured to indirectly or directly vibrate the seat interior material 130E and output sound based on a vibration of the seat interior material 130E.

The seat frame may include a first seat frame (or a driver seat frame), a second seat frame (or a passenger seat frame), a third seat frame (or a first rear seat frame), a fourth seat frame (or a second rear seat frame), and a fifth seat frame (or a third rear seat frame). The seat interior material 130E may include the first seat interior material surrounding the first seat frame, the second seat interior material surrounding the second seat frame, the third seat interior material surrounding the third seat frame, the fourth seat interior material surrounding the fourth seat frame, and the fifth seat interior material surrounding the fifth seat frame.

One or more of the first to fifth seat frames may include a seat bottom frame, a seat back frame, and a headrest frame. The seat interior material 130E may include a seat bottom interior material 130E1 surrounding the seat bottom frame, a seat back interior material 130E2 surrounding the seat back frame, and a headrest interior material 130E3 surrounding the headrest frame. One or more of the seat bottom interior material 130E1, the seat back interior material 130E2, and the headrest interior material 130E3 may include an inner interior material and an outer interior material.

The fifth sound generator 31E disposed at one or more of the driver seat DS, the passenger seat PS, and the first to third rear seats BS1, BS2, and BS3 may be disposed (or configured) at one or more of the outer interior material of the seat back interior material 130E2 and the outer interior material of the headrest interior material 130E3. For example, one or more of the outer interior material of the seat back interior material 130E2 and the outer interior material of the headrest interior material 130E3 of one or more among the driver seat DS, the passenger seat PS, and the first to third rear seats BS1, BS2, and BS3 may include a hole to accommodate a protrusion portion in an enclosure of a sound apparatus 30 configuring the fifth sound generator 31E.

Referring to FIGS. 21 and 22, the sixth sound generator 31F may be disposed between a handle frame and the handle interior material 130F and configured to output sound to the driver. Furthermore, the sixth sound generator 31F may be configured to indirectly or directly vibrate the handle interior material 130F to output sound based on a vibration of the handle interior material 130F. The sixth sound generator 31F may be configured to provide sound to the driver. For example, the handle interior material 130F may include a hole to accommodate a protrusion portion in an enclosure of a sound apparatus 30 configuring the sixth sound generator 31F.

Referring to FIGS. 21 and 22, the seventh sound generator 31G may be disposed between a floor panel and the floor interior material 130G and configured to output sound into the interior space. Furthermore, the seventh sound generator 31G may be configured to indirectly or directly vibrate the floor interior material 130G to output sound based on a vibration of the floor interior material 130G. For example, the floor interior material 130G may include a hole to accommodate a protrusion portion in an enclosure of a sound apparatus 30 configuring the seventh sound generator 31G.

Referring to FIGS. 21 to 23, the vehicular apparatus or the vehicle 10 according to an embodiment of the present disclosure may further include a second sound generating apparatus 30-2 which is disposed at the vehicle interior material 130 exposed at an interior space. For example, the vehicular apparatus or the vehicle 10 according to an embodiment of the present disclosure may include only the second sound generating apparatus 30-2 instead of the first sound generating apparatus 30-1 or may include all of the first sound generating apparatus 30-1 and the second sound generating apparatus 30-2.

The vehicle interior material 130 may further include a rear view mirror 130H, an overhead console 130I, a rear package interior material 130J, a glove box 130K, and a sun visor 130L, or the like.

The second sound generating apparatus 30-2 may include one or more sound generator 31H to 31L which are disposed in at least one of the rear view mirror 130H, the overhead console 130I, the rear package interior material 130J, the glove box 130K, and the sun visor 130L. For example, the second sound generating apparatus 30-2 may include one or more of eighth to twelfth sound generators 31H to 31L, and thus, may output sounds of one or more channels.

One or more of the eighth to twelfth sound generators 31H to 31L includes the sound apparatus 30 described above with reference to FIGS. 2 to 20, and thus, the repetitive descriptions are omitted.

Referring to FIGS. 21 to 23, the eighth sound generator 31H may be disposed in the rear view mirror 130H and configured to output sound into the interior space. Furthermore, the eighth sound generator 31H may be configured to indirectly or directly vibrate the rear view mirror 130H to output sound based on a vibration of the rear view mirror 130H. The eighth sound generator 31H may be disposed between a mirror housing connected to a vehicle body structure and the rear view mirror 130H supported by the mirror housing. For example, the rear view mirror 130H may include a hole to accommodate a protrusion portion in an enclosure of a sound apparatus 30 configuring the eighth sound generator 31H.

Referring to FIGS. 23 and 24, the ninth sound generator 31I may be disposed in the overhead console 130I and configured to output sound into the interior space. Furthermore, the ninth sound generator 31I may be configured to indirectly or directly vibrate a console cover of the overhead console 130I to output sound based on a vibration of an interior material of the overhead console 130I. The overhead console 130I may include a console box embedded into the roof panel, a lighting device disposed at the console box, and the console cover covering the lighting device and the console box. For example, the overhead console 130I may include a hole to accommodate a protrusion portion in an enclosure of a sound apparatus 30 configuring the ninth sound generator 31I.

Referring to FIGS. 21 and 22, the tenth sound generator 31J may be disposed in the rear package interior material 130J and configured to output sound into the interior space. Furthermore, the tenth sound generator 31J may be configured to indirectly or directly vibrate the rear package interior material 130J to output sound based on a vibration of the rear package interior material 130J. The rear package interior material 130J may be disposed behind the first to third rear seats BS1, BS2, and BS3. For example, a part of the rear package interior material 130J may be disposed under a rear window 230. For example, the rear package interior material 130J) may include a hole to accommodate a protrusion portion in an enclosure of a sound apparatus 30 configuring the tenth sound generator 31J.

Referring to FIGS. 21 and 22, the eleventh sound generator 31K may be disposed in the glove box 130K and configured to output sound into the interior space. Furthermore, the eleventh sound generator 31K may be configured to indirectly or directly vibrate the glove box 130K to output sound based on a vibration of the glove box 130K. For example, the eleventh sound generator 31K may be one or more of a woofer, a mid-woofer, and a sub-woofer. For example, the glove box 130K may include a hole to accommodate a protrusion portion in an enclosure of a sound apparatus 30 configuring the eleventh sound generator 31K.

Referring to FIG. 23, the twelfth sound generator 31L may be disposed in the sun visor 130L and configured to output sound into the interior space. Furthermore, the twelfth sound generator 31L may be configured to indirectly or directly vibrate the sun visor 130L to output sound based on a vibration of the sun visor 130L. The sun visor 130L may include a first sun visor 130L1 corresponding to the driver seat DS and a second sun visor 130L2 corresponding to the passenger seat PS. The twelfth sound generator 31L may be disposed (or configured) in one or more of the first sun visor 130L1 and the second sun visor 130L2. For example, one or more of the first sun visor 130L1 and the second sun visor 130L2 may include a hole to accommodate a protrusion portion in an enclosure of a sound apparatus 30 configuring the twelfth sound generator 31L.

Referring to FIGS. 21 and 22, the vehicular apparatus or the vehicle 10 according to an embodiment of the present disclosure may further include a woofer speaker WS which is disposed at one or more of the dashboard 130A, the door frame, and the rear package interior material 130J.

The woofer speaker WS may be one or more of a woofer, a mid-woofer, and a sub-woofer. For example, the woofer speaker WS may output a sound of about 60 Hz to about 150 Hz, and thus, may enhance a low-pitched sound band characteristic of a sound which is output to the interior space.

The woofer speaker WS may be disposed at one or more of first and second regions of the dashboard 130A. The woofer speaker WS may be disposed at one or more of the first to fourth door frames of the door frame and may be exposed at the lower regions of one or more of the first to fourth door interior materials 130D1, 130D2, 130D3, and 130D4 of the door interior material 130D. For example, the fourth sound generator 31D disposed at the lower region of one or more of the first to fourth door interior materials 130D1, 130D2, 130D3, and 130D4 may be replaced by the woofer speaker WS.

Referring to FIG. 22, the vehicular apparatus 10 according to an embodiment of the present disclosure may further include a garnish member 130P which covers a portion of the vehicle interior material 130 exposed at the interior space, and one or more third sound generating apparatuses 30-3.

The garnish member 130P may be configured to cover a portion of the door interior material 130D exposed to the interior space. For example, the garnish member 130P may be configured to cover a portion of one or more of the dashboard 130A, the pillar interior material 130B, and the roof interior material 130C, which are exposed at the interior space. For example, the garnish member 130P may include a metal material having a material characteristic suitable for generating a sound of a high-pitched sound band.

One or more third sound generating devices 30-3 may be disposed at the garnish member 130P and configured to output sound into the interior space. Furthermore, one or more third sound generating devices 30-3 may be configured to indirectly or directly vibrate the garnish member 130P to output a sound into the interior space of the vehicular apparatus 10.

The one or more third sound generating apparatuses 30-3 may be configured to output a sound of a high-pitched sound band. For example, the high-pitched sound band may have a frequency of 1 kHz or more, 2 kHz or more, or 3 kHz or more. The one or more third sound generating devices 30-3 may include one or more of the sound apparatus 30 described above with reference to FIGS. 2 to 20. For example, the garnish member 130P) may include a hole to accommodate a protrusion portion in an enclosure of a sound apparatus 30 configuring the one or more third sound generating devices 30-3.

The vehicular apparatus or the vehicle 10 according to an embodiment of the present disclosure may output a sound to the interior space IS through one or more of the first to third sound generating apparatuses 30-1, 30-2, and 30-3, and thus, may output the sound using a vehicle interior material 130 as a sound vibration plate, thereby outputting a multichannel surround stereo sound.

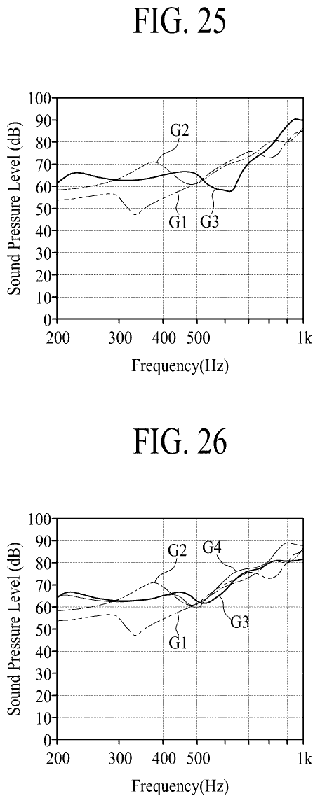

FIGS. 25 to 28 are diagrams illustrating sound output characteristics of a sound apparatus according to embodiments of the present disclosure and experimental examples.

In FIGS. 25 to 28, the abscissa axis represents a frequency in hertz (Hz), and the ordinate axis represents a sound pressure level (SPL) in decibels (dB).

The sound output characteristic may be measured by sound analysis equipment. The sound analysis equipment can include a control PC, a sound card for transmitting and receiving sound, an amplifier for amplifying and transmitting the sound generated from the sound card to the sound apparatus, and a microphone for collecting the sound generated in the apparatus based on driving of the vibration apparatus. The sound collected by the microphone is input to the control PC through the sound card, and the sound is checked in a control program to analyze the sound of the apparatus.

The sound output characteristic has been measured in an anechoic chamber, which is closed in all directions. When measuring, an applied frequency signal is applied as a sine sweep within a range of 200 Hz to 10 k Hz, and ⅙ octave smoothing has been performed on a measurement result. A separation distance between the apparatus and the microphone is adjusted to be 30 cm. However, a measurement method of the sound output characteristic can be not limited thereto.

In each of FIGS. 25 to 28, a dash-double dotted line (or an alternate long and two short dashes line) G1 represents a sound output characteristic of the sound apparatus according to the first experimental example that does not include the vibration control member described above with reference to FIGS. 2 to 6, and a dash-single dotted line (or an alternate long and short dash line) G2 represents a sound output characteristic of the sound apparatus according to the second experimental example that has two stacked vibration apparatuses without including the vibration control member described above with reference to FIGS. 2 to 6.

In FIG. 25, a thick solid line G3 represents the sound output characteristic of the sound apparatus including the vibration control member according to the first embodiment of the present disclosure described above with reference to FIGS. 2 to 6.

Referring to FIG. 25, comparing with the dash-double dotted line G1, it may be seen that the thick solid line G3 has a relatively high sound pressure level in frequencies (or sound band) of about 200 Hz to about 520 Hz. Comparing with the dash-single dotted line G2, it may be seen that the thick solid line G3 has a relatively high sound pressure level in a frequency of about 200 Hz to about 300 Hz and about 425 Hz to about 520 Hz.

Comparing with an average sound pressure level in frequencies (or sound band) from about 200 Hz to about 1 kHz, it has been measured that the dash-double dotted line G1 is approximately 62.9 dB, the dash-single dotted line G2 is approximately 68.2 dB, and the thick solid line G3 is approximately 67.9 dB. Therefore, it may be seen that the average sound pressure level of the sound apparatuses including the vibration control member according to the first embodiment (the thick solid line G3) of the present disclosure is higher than the average sound pressure level of the sound apparatus according to the first experimental example (the dash-double dotted line G1), and is slightly lower than the average sound pressure level of the sound apparatus according to the second experimental example (or the dash-single dotted line G2).

In FIG. 26, the thick solid line G3 represents a sound output characteristic of the sound apparatus including the vibration control member according to the second embodiment of the present disclosure described above with reference to FIG. 7, and a solid line G4 represents sound output characteristics of the sound apparatus including the vibration control member according to the third embodiment of the present disclosure described above with reference to FIG. 8.

Referring to FIG. 26, comparing with the dash-double dotted line G1, it may be seen that the thick solid line G3 has a relatively high sound pressure level in frequencies of about 200 Hz to about 510 Hz. Comparing with the dash-double dotted line G1, it may be seen that the solid line G4 has a relatively high sound pressure level in frequencies of about 200 Hz to about 485 Hz and about 560 Hz to about 1 kHz. Comparing with the dash-single dotted line G1, it may be seen that the thick solid line G3 has a relatively high sound pressure level in a frequency of about 200 Hz to about 290 Hz, about 420 Hz to about 510 Hz, and about 620 Hz to about 900 Hz. Comparing with the dash-single dotted line G2, it may be seen that the solid line G3 has a relatively high sound pressure level in a frequency of about 200 Hz to about 290 Hz, about 430 Hz to about 480 Hz, and about 540 Hz to about 1 kHz.

Comparing with an average sound pressure level in frequencies (or sound band) from about 200 Hz to about 1 kHz, it has been measured that the dash-double dotted line G1 is approximately 62.9 dB, the dash-single dotted line G2 is approximately 68.2 dB, the thick solid line G3 is approximately 68.7 dB, and the solid line G4 is approximately 69.7 dB. Therefore, it may be seen that the average sound pressure level of each of the sound apparatuses including the vibration control member according to the second embodiment (the thick solid line G3) and the third embodiment (the solid line G4) of the present disclosure is higher than the average sound pressure level of the sound apparatus according to the first experimental example (the dash-double dotted line G1), and is higher than the average sound pressure level of the sound apparatus according to the second experimental example (or the dash-single dotted line G2).

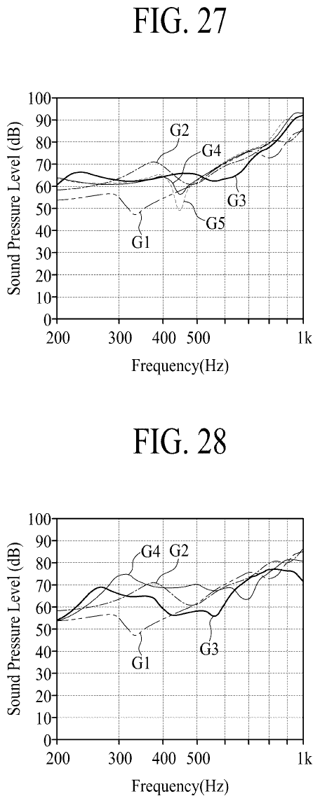

In FIG. 27, the thick solid line G3 represents a sound output characteristic of the sound apparatus including the vibration control member according to the fourth embodiment of the present disclosure described above with reference to FIG. 9, and a solid line G4 represents sound output characteristics of the sound apparatus including the vibration control member according to the fifth embodiment of the present disclosure described above with reference to FIG. 10. A dotted line G5 represents a sound output characteristic of the sound apparatus including the vibration control member according to the sixth embodiment of the present disclosure described above with reference to FIG. 11.

Referring to FIG. 27, comparing with the dash-double dotted line G1, it may be seen that the thick solid line G3 has a relatively high sound pressure level in frequencies of about 200 Hz to about 520 Hz. Comparing with the dash-double dotted line G1, it may be seen that the solid line G4 has a relatively high sound pressure level in frequencies of about 200 Hz to about 440 Hz and about 470 Hz to about 1 kHz. Comparing with the dash-double dotted line G1, it may be seen that the dotted line G5 has a relatively high sound pressure level in frequencies of about 200 Hz to about 430 Hz and about 480 Hz to about 1 kHz. Comparing with the dash-single dotted line G2, it may be seen that the thick solid line G3 has similar sound pressure level in a frequency of about 200 Hz to about 295 Hz and about 430 Hz to about 530 Hz. Comparing with the dash-single dotted line G2, it may be seen that the solid line G4 has similar sound pressure level in a frequency of about 200 Hz to about 270 Hz and about 480 Hz to about 1 kHz. Comparing with the dash-single dotted line G2, it may be seen that the dotted line G5 has a relatively high sound pressure level in a frequency of about 200 Hz to about 275 Hz, about 485 Hz to about 1 kHz.

Comparing with an average sound pressure level in frequencies (or sound band) from about 200 Hz to about 1 kHz, it has been measured that the dash-double dotted line G1 is approximately 62.9 dB, the dash-single dotted line G2 is approximately 68.2 dB, the thick solid line G3 is approximately 68.4 dB, the solid line G4 is approximately 68.6 dB, and the dotted line G5 is approximately 68.6 dB. Therefore, it may be seen that the average sound pressure level of each of the sound apparatuses including the vibration control member according to the fourth embodiment (the thick solid line G3), the fifth embodiment (the solid line G4), and the sixth embodiment (the dotted line G5) of the present disclosure is higher than the average sound pressure level of the sound apparatus according to the first experimental example (the dash-double dotted line G1), and is higher than the average sound pressure level of the sound apparatus according to the second experimental example (or the dash-single dotted line G2).

In FIG. 28, the thick solid line G3 represents a sound output characteristic of the sound apparatus including the vibration control member according to the seventh embodiment of the present disclosure described above with reference to FIG. 12, and a solid line G4 represents sound output characteristics of the sound apparatus including the vibration control member according to the eighth embodiment of the present disclosure described above with reference to FIG. 13.

Referring to FIG. 28, comparing with the dash-double dotted line G1, it may be seen that the thick solid line G3 has a relatively high sound pressure level in frequencies of about 200 Hz to about 425 Hz. Comparing with the dash-double dotted line G1, it may be seen that the solid line G4 has a relatively high sound pressure level in frequencies of about 200 Hz to about 560 Hz. Comparing with the dash-single dotted line G2, it may be seen that the thick solid line G3 has a relatively high sound pressure level in a frequency of about 225 Hz to about 315 Hz. Comparing with the dash-single dotted line G2, it may be seen that the solid line G4 has a relatively high sound pressure level in a frequency of about 240 Hz to about 360 Hz and about 405 Hz to about 575 Hz.

Comparing with an average sound pressure level in frequencies (or sound band) from about 200 Hz to about 1 kHz, it has been measured that the dash-double dotted line G1 is approximately 62.9 dB, the dash-single dotted line G2 is approximately 68.2 dB, the thick solid line G3 is approximately 65.0 dB, and the solid line G4 is approximately 68.9 dB. Therefore, it may be seen that the average sound pressure level of each of the sound apparatuses including the vibration control member according to the seventh embodiment (the thick solid line G3) and the eighth embodiment (the solid line G4) of the present disclosure is higher than the average sound pressure level of the sound apparatus according to the first experimental example (the dash-double dotted line G1). Furthermore, it may be seen that the average sound pressure level of each of the sound apparatuses including the vibration control member according to the eighth embodiment (the solid line G4) is higher than the average sound pressure level of the sound apparatus according to the second experimental example (or the dash-single dotted line G2).

As described above, according to FIGS. 25 to 28, the sound apparatus according to one or more embodiments of the present disclosure includes the vibration control member, and thus, the sound characteristic and/or the sound pressure level characteristic of the low-pitched sound band (for example, about 200 Hz to about 500 Hz (or 600 Hz)) may be improved (or enhanced). Furthermore, the sound apparatus according to one or more embodiments of the present disclosure includes one vibration apparatus and one vibration control member, and thus, may generate (or output) sound having higher or slightly lower sound pressure level characteristic than the sound apparatus according to the second experimental example based on vibration (or displacement) of the one vibration apparatus.

The sound apparatus according to one or more embodiments of the present disclosure may be applied to or included in a sound apparatus disposed at an apparatus (or a display apparatus). The apparatus (or the display apparatus) according to an embodiment of the present disclosure may be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. Further, the sound apparatus according to one or more embodiments of the present disclosure may be applied to or included in an organic light-emitting lighting apparatus or an inorganic light-emitting lighting apparatus. When the sound apparatus is applied to or included in the lighting apparatuses, the lighting apparatuses may act as lighting and a speaker. In addition, when the sound apparatus according to one or more embodiments of the present disclosure is applied to or included in the mobile apparatuses, or the like, the sound apparatus may be one or more of a speaker, a receiver, and a haptic device.

It will be apparent to those skilled in the art that various modifications and variations can be made in the present disclosure without departing from the spirit or scope of the disclosures. Thus, it is intended that the present disclosure covers the modifications and variations of this disclosure provided that within the scope of the claims and their equivalents.

What is claimed is:

1. A sound apparatus, comprising:
a sound generating module including a vibration member and a vibration apparatus, the vibration apparatus configured to vibrate the vibration member;
an enclosure connected to the vibration member, the enclosure having an opening portion overlapping the vibration apparatus; and
a vibration control member disposed around the vibration apparatus in a gap space between the enclosure and a rear surface of the vibration member, the vibration control member connected between the enclosure and the rear surface of the vibration member,
wherein the vibration control member is inclined with respect to a side of the vibration apparatus.

2. The sound apparatus of claim 1, wherein the vibration control member includes plastic material or metal material.

3. The sound apparatus of claim 1, wherein:
the vibration apparatus includes a short side and a long side, and
the vibration control member is inclined at one or more of the short side and the long side of the vibration apparatus and is in contact with one of the short side and the long side of the vibration apparatus.

4. The sound apparatus of claim 1, wherein:
the vibration apparatus includes a first short side, a second short side parallel to the first short side, a first long side, and a second long side parallel to the first long side, and
the vibration control member comprises:
a first vibration control member inclined around the first short side of the vibration apparatus; and
a second vibration control member inclined around the second short side of the vibration apparatus.

5. The sound apparatus of claim 4, wherein:
the first vibration control member is in contact with the first short side of the vibration apparatus or is spaced apart from the first short side of the vibration apparatus,
the second vibration control member is in contact with the second short side of the vibration apparatus or is spaced apart from the second short side of the vibration apparatus, and
the first vibration control member and the second vibration control member are symmetrical with respect to a center of the vibration apparatus.

6. The sound apparatus of claim 5, wherein:
the first vibration control member includes a 1-1^{th} vibration control pad and a 1-2^{th} vibration control pad that are inclined with respect to the first short side of the vibration apparatus,
the second vibration control member includes a 2-1^{th} vibration control pad and a 2-2^{th} vibration control pad that are inclined with respect to the second short side of the vibration apparatus,
the 1-1^{th} vibration control pad and the 1-2^{th} vibration control pad are symmetrical with respect to the center of the vibration apparatus, and
the 2-1^{th} vibration control pad and the 2-2^{th} vibration control pad are symmetrical with respect to the center of the vibration apparatus.

7. The sound apparatus of claim 6, wherein the first vibration control member comprises a “>”-shape or a “<”-shape in a plane by the 1-1^{th} vibration control pad and the 1-2^{th} vibration control pad.

8. The sound apparatus of claim 7, wherein a length of each of the 1-1^{th} vibration control pad and the 1-2^{th} vibration control pad is shorter or longer than a short-side length of the vibration apparatus.

9. The sound apparatus of claim 7, wherein:
each of the 1-1^{th} vibration control pad and the 1-2^{th} vibration control pad is spaced apart from the first short side of the vibration apparatus,
each of the 1-1^{th} vibration control pad and the 1-2^{th} vibration control pad has a length equal to half a short-side length of the vibration apparatus.

10. The sound apparatus of claim 1, wherein:
the vibration apparatus includes a first short side, a second short side parallel to the first short side, a first long side, and a second long side parallel to the first long side, and
the vibration control member comprises:
a third vibration control member inclined around the first long side of the vibration apparatus; and
a fourth vibration control member inclined around the second long side of the vibration apparatus.

11. The sound apparatus of claim 10, wherein:
the third vibration control member is in contact with an edge portion of the first long side of the vibration apparatus,
the fourth vibration control member is in contact with an edge portion of the second long side of the vibration apparatus, and
a third vibration control pad and a fourth vibration control pad are symmetrical with respect to a center of the vibration apparatus.

12. The sound apparatus of claim 11, wherein:
the third vibration control member includes a 3-1^{th} vibration control pad and a 3-2^{th} vibration control pad that are inclined with respect to the first long side of the vibration apparatus,
the fourth vibration control member includes a 4-1^{th} vibration control pad and a 4-2^{th} vibration control pad that are inclined with respect to the second long side of the vibration apparatus,
the 3-1^{th} vibration control pad and the 3-2^{th} vibration control pad are symmetrical with respect to the center of the vibration apparatus, and
the 4-1^{th} vibration control pad and the 4-2^{th} vibration control pad are symmetrical with respect to the center of the vibration apparatus.

13. The sound apparatus of claim 12, wherein:
one end of each of the 3-1^{th} vibration control pad and the 3-2^{th} vibration control pad are in contact with the edge portion of the first long side of the vibration apparatus, and
another end of each of the 3-1^{th} vibration control pad and the 3-2^{th} vibration control pad are spaced apart from a center of the first long side of the vibration apparatus.

14. The sound apparatus of claim 12, wherein:
another end of the 3-1^{th} vibration control pad and another end of the 3-2^{th} vibration control pad are connected to each other, and
a length of each of the 3-1^{th} vibration control pad and the 3-2^{th} vibration control pad is longer than a short-side length of the vibration apparatus.

15. The sound apparatus of claim 11, wherein the vibration control member further comprises:
a first vibration control member inclined around the first short side of the vibration apparatus and spaced apart from the first short side of the vibration apparatus; and
a second vibration control member inclined around the second short side of the vibration apparatus and spaced apart from the second short side of the vibration apparatus,
wherein a first vibration control pad and a second vibration control pad are symmetrical with respect to the center of the vibration apparatus.

16. The sound apparatus of claim 15, wherein:
the first vibration control member includes a 1-1^{th} vibration control pad and a 1-2^{th} vibration control pad that are inclined with respect to the first short side of the vibration apparatus,
the second vibration control member includes a 2-1^{th} vibration control pad and a 2-2^{th} vibration control pad that are inclined with respect to the second short side of the vibration apparatus,
the 1-1^{th} vibration control pad and the 1-2^{th} vibration control pad are symmetrical with respect to the center of the vibration apparatus, and
the 2-1^{th} vibration control pad and the 2-2^{th} vibration control pad are symmetrical with respect to the center of the vibration apparatus.

17. The sound apparatus of claim 16, wherein:
each of the 1-1^{th} vibration control pad and the 1-2^{th} vibration control pad is spaced apart from the first short side of the vibration apparatus,
each of the 1-1^{th} vibration control pad and the 1-2^{th} vibration control pad has a length equal to half a short-side length of the vibration apparatus.

18. The sound apparatus of claim 1, further comprising:
a coupling member connected between a rear edge of the vibration member and the enclosure and provides a gap space,
wherein the vibration control member is between the vibration apparatus and the coupling member within the gap space and is in contact with the coupling member or spaced apart from the coupling member.

19. The sound apparatus of claim 1, wherein:
the enclosure comprises a plate having the opening portion, and
the vibration control member is connected to the rear surface of the vibration member through a first adhesive member and connected to the plate through a second adhesive member.

20. The sound apparatus of claim 19, wherein the enclosure further comprises a protrusion portion protruding from a rear surface of the plate, surrounds the opening portion, and has a sound output hole connected to the opening portion.

21. The sound apparatus of claim 1, wherein:
the enclosure comprises a plate having the opening portion, and
the vibration control member protrudes from the plate and is connected to the rear surface of the vibration member through an adhesive member.

22. The sound apparatus of claim 21, wherein the enclosure further comprises a protrusion portion protruding from a rear surface of the plate, surrounds the opening portion, and has a sound output hole connected to the opening portion.

23. A vehicular apparatus, comprising:
an interior material exposed at an interior space; and
at least one or more sound generating apparatuses disposed at the interior material, the at least one or more sound generating apparatuses configured to output a sound to the interior space,
wherein the at least one or more sound generating apparatuses comprise the sound apparatus of claim 1.

24. The vehicular apparatus of claim 23, wherein:
the enclosure comprises a plate having the opening portion, and
the vibration control member is connected to the rear surface of the vibration member through a first adhesive member and connected to the plate through a second adhesive member.

25. The vehicular apparatus of claim 24, wherein:
the enclosure further comprises a protrusion portion protruding from a rear surface of the plate, surrounds the opening portion, and has a sound output hole connected to the opening portion, and
the interior material includes a hole to accommodate the protrusion portion.

26. The vehicular apparatus of claim 23, wherein:
the enclosure comprises a plate having the opening portion, and
the vibration control member protrudes from the plate and is connected to the rear surface of the vibration member through an adhesive member.

27. The vehicular apparatus of claim 26, wherein:
the enclosure further comprises a protrusion portion protruding from a rear surface of the plate, surrounds the opening portion, and has a sound output hole connected to the opening portion, and
the interior material includes a hole to accommodate the protrusion portion.
